(19) United States
(12) Patent Application Publication
(10) Pub. No.: US 2026/0311264 A1
(43) Pub. Date: Oct. 8, 2026

(54) SYSTEMS AND METHODS FOR PROCESSING INSURANCE CLAIMS USING AGENTIC ARTIFICIAL INTELLIGENCE (AI) MODELS

(71) Applicant: Autonomize Inc., Austin, TX (US)

(72) Inventors: Lakshminarayanan Krishnamurthy, Austin, TX (US); Utkarsh Mujumdar, Austin, TX (US); Ganesh Padmanabhan, Austin, TX (US); Kris Nair, Austin, TX (US); Prithviraj Elangovan, Austin, TX (US)

(21) Appl. No.: 19/637,396

(22) Filed: Apr. 2, 2026

Related U.S. Application Data
(60) Provisional application No. 63/782,067, filed on Apr. 2, 2025.

(51) Int. Cl. G06Q 40/08; G06F 40/205

(52) U.S. Cl. CPC G06Q 40/09; G06F 40/205; G06Q 40/0822; G06Q 40/084

(57) ABSTRACT

Systems and methods for processing insurance claims using agentic artificial intelligence (AI) models are disclosed. Further, the computer implemented system may receive input data. Furthermore, the computer implemented system may extract a plurality of decision rules. Additionally, the computer implemented system may transform the extracted decision rules into a graph-based decision structure. Further, the computer implemented system may generate an initial result for the insurance claim. Further, the computer implemented system may generate a stepwise reasoning path. Furthermore, the computer implemented system may validate diagnosis codes, procedure codes, claimant attributes, and coverage conditions. Additionally, the computer implemented system may detect inconsistency in the coverage conditions and missing supporting claim data. Further, the computer implemented system may generate structured feedback. Furthermore, the computer implemented system may generate a final adjudication result. Further, the computer implemented system may output the final result and an explanation data for the final.

### CROSS-REFERENCE TO RELATED APPLICATIONS

This application claims the benefit of the earlier-filed provisional application 63/782,067, filed on Apr. 2, 2025, entitled “ARTIFICIAL INTELLIGENCE-BASED SYSTEM AND METHOD FOR DETERMINING INSURANCE CLAIM ADJUDICATION,” the contents of which are incorporated herein by reference.

### TECHNICAL FIELD

Embodiments of the present disclosure generally relate to automated insurance claim processing systems, and more particularly relate to systems and methods for processing insurance claims using agentic Artificial Intelligence (AI) models.

### BACKGROUND

Health insurance claim processing represents one of the most complex and resource-intensive operations within the insurance industry. Adjudication of an insurance claim traditionally demands substantial manual intervention from insurance claim adjusters, resulting in inefficiencies, inconsistencies, and errors across the adjudication workflow.

A main challenge in insurance claim adjudication stems from the fragmented and scattered nature of relevant claim information. Insurance claim adjusters are required to navigate across multiple databases, historical claim records, and voluminous insurance policy documents to collect all data necessary for arriving at an informed adjudication decision. Such a fragmented approach introduces delays, potential oversights, and an increased probability of non-compliance with applicable policy terms during the adjudication process.

A further challenge relates to the time required to process insurance claims at scale. Capturing all required claim information, comparing the captured information against decision rules embedded across insurance policy documents, evaluating multiple coverage scenarios, and forming a final adjudication decision places a significant burden on insurance claim adjusters. As the volume of insurance claims filed across the industry continues to grow, the limitations of manual adjudication workflows become increasingly untenable for insurance organizations seeking to maintain operational efficiency and regulatory compliance.

Prior efforts within the insurance industry to address adjudication inefficiencies have focused primarily on standardizing claim formats and automating isolated aspects of the adjudication workflow. However, the inherent complexity of insurance policy structures, combined with the nuanced and context-dependent nature of medical diagnosis codes, procedure codes, and treatment determinations, has continued to necessitate human judgment at critical decision points. Full automation of the adjudication process has therefore remained a persistent challenge for the industry.

Advancements in artificial intelligence and natural language processing have disclosed new possibilities for improving the efficiency and accuracy of insurance claim processing. Further, existing AI-based systems provide potential for interpreting complex insurance policy documents, analyzing claimant histories, and applying coverage rules consistently across large volumes of insurance claims. However, existing AI-based approaches continue to encounter significant limitations in relation to data complexity, multi-source system integration, decision transparency, and their capacity to produce reliable, auditable adjudication outcomes across diverse claim scenarios.

A further limitation of existing systems is the absence of structured mechanisms for detecting inconsistencies in the application of coverage conditions, identifying missing or insufficient claim data, and generating actionable feedback to support re-evaluation of adjudication decisions. Without such mechanisms, automated adjudication systems remain susceptible to erroneous outcomes and are ill-equipped to handle evolving regulatory requirements and the increasing complexity of insurance policy structures.

Consequently, there may be a need for a systems and methods for processing insurance claims using agentic Artificial Intelligence (AI) models to automate decision rule extraction, construct structured decision representations from insurance policy documents, generate transparent reasoning paths, validate adjudication decisions against a domain-specific knowledge graph, and produce reliable final adjudication results along with corresponding explanation data.

### SUMMARY

This section is provided to introduce certain objects and aspects of the present disclosure in a simplified form that are further described below in the detailed description. This summary is not intended to identify the key features or the scope of the claimed subject matter.

In one aspect of the present disclosure, a computer implemented system for processing insurance claims using agentic Artificial Intelligence (AI) models. The computer implemented system may be configured to receive input data corresponding to an insurance from at least one user. The input data includes an insurance claim, a claimant history data, and a plurality of insurance policy documents. Further, the computer implemented system may be configured to extract a plurality of decision rules corresponding to the received input data by processing the plurality of insurance policy documents within the received input data using a first Generative Artificial Intelligence (Gen AI) model. The plurality of decision rules corresponds to a natural language data format. Furthermore, the computer implemented system may be configured to transform the extracted plurality of decision rules into a graph-based decision structure. The graph-based decision structure may include a decision tree with a plurality of nodes and a plurality of edges. Each node may represent a respective coverage condition obtained from the plurality of insurance policy documents. Furthermore, the computer implemented system may be configured to generate an initial result for the insurance claim by evaluating the decision tree using a second Gen AI model. Further, the computer implemented system may be configured to generate a stepwise reasoning path corresponding to a traversal of the decision tree using a third Gen AI model based on the generated initial result. The third Gen AI model corresponds to a chain-of-thought reasoning model. Furthermore, the computer implemented system may be configured to validate at least one of diagnosis codes, procedure codes, claimant attributes, and coverage conditions corresponding to the plurality of nodes of the decision tree by querying a pre-determined domain-specific knowledge graph. The pre-determined domain-specific knowledge graph may include relationships among the plurality of decision rules. Furthermore, the computer implemented system may be configured to detect at least one of an inconsistency in the coverage conditions and missing supporting claim data based on the generated stepwise reasoning path, results of validation and the pre-determined domain-specific knowledge graph. Further, the computer implemented system may be configured to generate a structured feedback for the insurance claim using the third Gen AI model. The structured feedback may indicate a subset of nodes requiring re-evaluation and subsequent relevant claim data to be retrieved. Further, the computer implemented system may be configured to generate a final adjudication result by fine-tuning the traversal of the decision tree and updating the initial result using the second Gen AI model based on the structured feedback. Furthermore, the computer implemented system may be configured to output the final result and an explanation data for the final result on a user interface of a user device.

In another aspect of the present disclosure, a method for processing insurance claims using the agentic Artificial Intelligence (AI) models. The method may include receiving, by a processor, input data corresponding to an insurance from at least one user. The input data may include an insurance claim, a claimant history data, and a plurality of insurance policy documents. Further, the method may include extracting, by the processor, a plurality of decision rules corresponding to the received input data by processing the plurality of insurance policy documents within the received input data using a first Generative Artificial Intelligence (Gen AI) model. The plurality of decision rules corresponds to a natural language data format. Furthermore, the method may include transforming, by the processor, the extracted plurality of decision rules into a graph-based decision structure. The graph-based decision structure may include a decision tree with a plurality of nodes and a plurality of edges. Each node may represent a respective coverage condition obtained from the plurality of insurance policy documents. Furthermore, the method may include generating, by the processor, an initial result for the insurance claim by evaluating the decision tree using a second Gen AI model. Further, the method may include generating, by the processor, a stepwise reasoning path corresponding to a traversal of the decision tree using a third Gen AI model based on the generated initial result. The third Gen AI model corresponds to a chain-of-thought reasoning model. Furthermore, the method may include validating, by the processor, at least one of diagnosis codes, procedure codes, claimant attributes, and coverage conditions corresponding to the plurality of nodes of the decision tree by querying a pre-determined domain-specific knowledge graph. The pre-determined domain-specific knowledge graph may include relationships among the plurality of decision rules. Furthermore, the method may include detecting, by the processor, at least one of an inconsistency in the coverage conditions and missing supporting claim data based on the generated stepwise reasoning path, results of validation and the pre-determined domain-specific knowledge graph. Furthermore, the method may include generating, by the processor, a structured feedback for the insurance claim using the third Gen AI model. The structured feedback may indicate a subset of nodes requiring re-evaluation and subsequent relevant claim data to be retrieved. Furthermore, the method may include generating, by the processor, a final adjudication result by fine-tuning the traversal of the decision tree and updating the initial result using the second Gen AI model based on the structured feedback. Further, the method may include outputting, by the processor, the final result and an explanation data for the final result on a user interface of a user device.

In another aspect of the present disclosure, a computer-program product, having machine-readable instructions stored therein, that when executed by a processor (s), cause the processor (s) to perform the steps as described in the above claims.

To further clarify the features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an example block diagram of a computer environment, for processing insurance claims using agentic Artificial Intelligence (AI) models, in accordance with an embodiment of the present disclosure;

FIG. 2 illustrates an example block diagram representation of the computer implemented system, as shown in FIG. 1, for processing insurance claims using agentic Artificial Intelligence (AI) models, in accordance with an embodiment of the present disclosure.

FIG. 3 illustrates an example flow diagram representation depicting an operational flow of the computer-implemented system for processing insurance claim adjudication using agentic Artificial Intelligence (AI) models, according to an example embodiment of the present disclosure;

FIG. 4 illustrates an example flowchart depicting an example method for processing insurance claims using agentic Artificial Intelligence (AI) models, according to an example embodiment of the present disclosure.

FIG. 5 illustrates an example block diagram of an agentic ensemble for processing insurance claim adjudication using the agentic Artificial Intelligence (AI) models within the computer implemented system, according to an example embodiment of the present disclosure;

FIG. 6 illustrates a block diagram of an advanced agentic optimization layer for processing insurance claim adjudication within the computer implemented system, according to an example embodiment of the present disclosure;

FIG. 7 illustrates an example block diagram representation of an iterative adjudication workflow for processing insurance claim adjudication using the second and the third AI model within the computer implemented system, according to an example embodiment of the present disclosure; and

FIG. 8 illustrates an example block diagram representation of a federated fine-tuning workflow for the Generative Artificial Intelligence (AI) models across a plurality of insurance systems within the computer implemented system 102, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

An object of the present disclosure is to automate the insurance claim adjudication process using a plurality of Large Language Model (LLM) agents configured to interpret both structured and unstructured data present across a plurality of information sources including at least one of insurance claims, claimant history records, and insurance policy documents, and to interpret the extracted information in a manner that may support the adjudication decisioning workflow of the computer implemented system.

Further, another object of the present disclosure may be to significantly reduce average processing times for individual insurance claims by replacing manual adjudication operations with automated agentic AI-based processing performed by the modules 108 of the computer implemented system.

Further, another object of the present disclosure may be to enhance the accuracy of adjudication decisions generated as part of the adjudication decisioning workflow by ensuring that the underlying decision process aligns with the plurality of decision rules outlined in the insurance policy documents, thereby reducing the likelihood of errors in insurance claim adjudication outcomes generated by the computer implemented system.

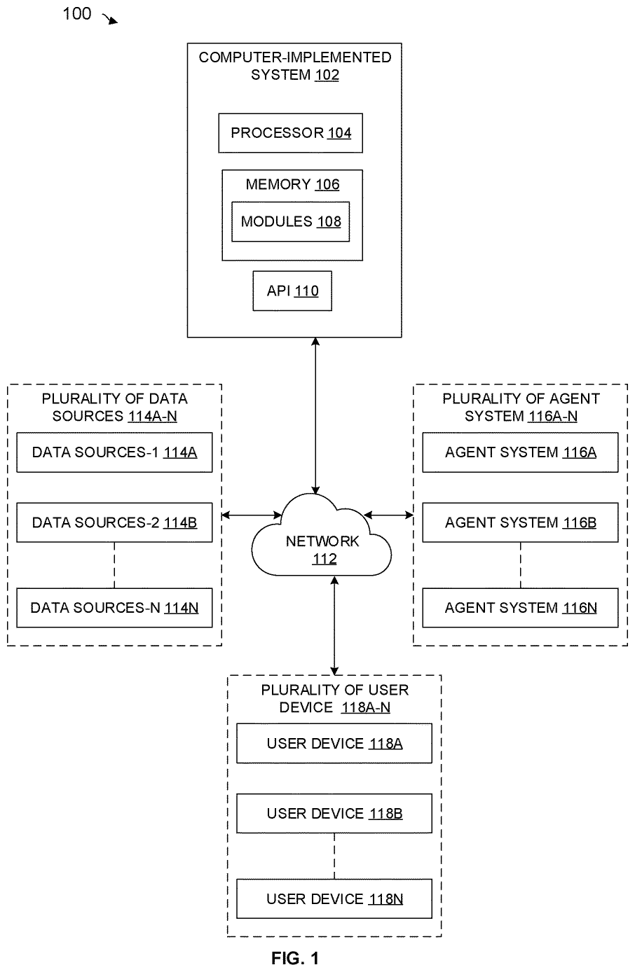

Referring now to the drawings, and more particularly to FIG. 1 through FIG. 8, where similar reference characters denote corresponding features consistently throughout the figures, there are shown preferred embodiments, and these embodiments are described in the context of the following exemplary system and/or method.

FIG. 1 illustrates an example block diagram of a computer environment 100, for processing insurance claims using agentic Artificial Intelligence (AI) models, in accordance with an embodiment of the present disclosure.

The computer environment 100 may include a computer implemented system 102, a processor 104, a memory 106, an Application Programming Interface (API) 110a, plurality of data sources 114A-N (hereinafter referred to as “data sources 114A-N”), a plurality of agent systems 116A-N (hereinafter referred to as “agent systems 116A-N”), and a plurality of user devices 118A-N (hereinafter referred to as “user devices 118A-N”). The computer implemented system 102, the data sources 114A-N, the agent systems 116A-N, and the user devices 118A-N may be communicably coupled over a network 112.

The computer implemented system 102 may represent a server-side processing infrastructure that may be configured to receive insurance claims, process insurance policy documents, and generate adjudication results. Further, the computer implemented system 102 may include the processor 104, the memory 106 communicably coupled to the processor 104, a plurality of modules 108 stored in the memory 106, and an Application Programming Interface (API) 110. Further, the processor 104 may execute instructions stored in the memory 106 to perform operations associated with insurance claim adjudication. Furthermore, the modules 108 may correspond to functional software components that implement agentic AI-based adjudication operations. Furthermore, the API 110 may utilize communication between the computer implemented system 102 and the data sources 114A-N, the agent systems 116A-N, and the user devices 118A-N over the network 112.

Further, the computer implemented system 102 may include the processor 104 and the memory 106. Further, the memory 106 may store the plurality of modules 108. Furthermore, the processor 104 may execute machine-readable processor-executable instructions stored within the memory 106 to perform one or more operations associated with insurance claim adjudication within the computer environment 100 described herein. Further, hardware implementations of the computer implemented system 102 may include a combination of discrete components, an integrated circuit, an application-specific integrated circuit, a field-programmable gate array, or a digital signal processor. Furthermore, software implementations may include one or more objects, agents, threads, lines of code, subroutines, separate software applications, or other suitable software structures operating in one or more software applications or on one or more processors.

Further, the processor 104 may be any type of computational circuit suitable for executing agentic AI-based adjudication operations. Further, in an example embodiment, the processor 104 may be a microprocessor unit, a microcontroller, a complex instruction set computing microprocessor unit, a reduced instruction set computing microprocessor unit, a very long instruction word microprocessor unit, an explicitly parallel instruction computing microprocessor unit, a graphics processing unit, or a digital signal processing unit. Furthermore, the processor 104 may also be an embedded controller, a generic or programmable logic device, a programmable logic array, an application-specific integrated circuit, or a single-chip computer. Further, the processor 104 may operate in parallel with one or more additional processors within the computer implemented system 102 to support scalable, low-latency insurance claim adjudication operations without impacting normal system operations of the computer environment 100.

Further, the memory 106 may store processor-executable instructions which, upon execution by the processor 104, may cause the processor 104 to perform one or more operations associated with receiving insurance claim input data, extracting decision rules from insurance policy documents using a first Generative AI (Gen AI) model, constructing a graph-based decision structure, generating an initial adjudication result using a second Gen AI model, generating a stepwise reasoning path using a third Gen AI model, validating coverage conditions against a domain-specific knowledge graph, detecting inconsistencies and missing claim data, generating structured feedback, and producing a final adjudication result with corresponding explanation data, as described herein.

Further, the memory 106 may be a non-transitory volatile memory, a non-volatile memory, or a combination thereof. Further, the memory 106 may be coupled to communicate with the processor 104 as a computer-readable storage medium. Furthermore, the processor 104 may execute machine-readable instructions stored within the memory 106 to perform operations of the agentic AI-based insurance claim adjudication system 102 described herein.

Further, the memory 106 may include any suitable elements for storing data and machine-readable instructions associated with insurance claim adjudication processing. Further, in an example embodiment, the memory 106 may be a read-only memory, a random-access memory, an erasable programmable read-only memory, an electrically erasable programmable read-only memory, a hard drive, a removable media drive, a compact disk drive, a digital video disk drive, a magnetic tape cartridge, or a memory card. Furthermore, the memory 106 may store the modules 108 in the form of machine-readable instructions on one or more of the above-mentioned storage media and may remain in communication with the processor 104 during execution of adjudication operations described herein.

Further, the network 112 may represent a communication infrastructure that enables data exchange among the computer implemented system 102, the data sources 114A-N, the agent systems 116A-N, and the user devices 118A-N. Further, the network 112 may include at least one of a local area network, a wide area network, the Internet, or a wireless communication network.

Further, the data sources 114A-N may represent a plurality of internal and external repositories configured to provide claim-related data during adjudication processing. Further, the data sources 114A-N may include insurance claim databases, claimant history records, insurance policy document repositories, diagnosis code databases, procedure code databases, and domain-specific knowledge graphs. Furthermore, data retrieved from the data sources 114A-N may be transmitted to the computer implemented system 102 via the network 112 for processing by the modules 108.

Further, the agent systems 116A-N may represent a plurality of agentic AI processing units configured to perform specialized tasks within an adjudication pipeline. the agent systems 116A-N may include a first Generative Artificial Intelligence (Gen AI) model, a second Generative Artificial Intelligence (Gen AI) model and a third Generative Artificial Intelligence (Gen AI) model. Further, the agent systems 116A-N may correspond to an independent AI agent responsible for at least one of decision rule extraction, decision tree traversal, reasoning generation, knowledge graph validation, and structured feedback generation. Furthermore, the agent systems 116A-N may communicate with the computer implemented system 102 via the API 110 over the network 112.

Further, the user devices 118A-N may represent client-side devices configured to enable interaction with the computer implemented system 102. Further, the user devices 118A-N may include devices operated by insurance claim adjusters, claimants, and authorized administrators. Furthermore, each of the user devices 118A-N, may include at least one of a desktop computer, a laptop computer, a tablet device, or a mobile device. Furthermore, the user devices 118A-N may be configured to submit insurance claims as input data to the computer implemented system 102 and receive final adjudication results along with corresponding explanation data via the network 112.

In an example embodiment, the computer implemented system 102 for processing insurance claims using agentic Artificial Intelligence (AI) models. Further, the computer implemented system 102 may be configured to receive input data corresponding to an insurance from at least one user device 118A-N. Further, the term ‘input data’ may refer to data received by the computer implemented system 102 for processing the insurance claim. The input data may include fir example, but not limited to, an insurance claim, claimant history data, and a plurality of insurance policy documents. The input data may include an insurance claim, a claimant history data, and a plurality of insurance policy documents from data sources 114A-N. Further, the term ‘insurance claim’ may refer to a request for reimbursement or coverage submitted by a claimant to an insurance provider, including details of medical services, treatments, procedures, and associated cost. Further, the term ‘claimant history data’ may refer to historical information associated with the claimant, including prior insurance claims, medical history, treatment records, coverage utilization, and claim adjudication outcomes. Further, the term ‘insurance policy documents may refer to one or more documents defining coverage terms, conditions, exclusions, eligibility criteria, reimbursement rules, and policy-specific provisions applicable to the insurance claim. Further, the computer implemented system 102 may be configured to extract a plurality of decision rules corresponding to the received input data by processing the plurality of insurance policy documents within the received input data using a first Generative Artificial Intelligence (Gen AI) model. Further, the term ‘plurality of decision rules may refer to a set of rule constructs derived from insurance policy documents, each rule representing a condition-action relationship that governs evaluation of coverage, eligibility, exclusions, or reimbursement associated with an insurance claim. Further, the term ‘first Generative Artificial Intelligence (Gen AI) model’ may refer to an artificial intelligence model that may be configured to process unstructured or semi-structured data, including insurance policy documents, and generate structured outputs, including the plurality of decision rules, in a natural language or machine-interpretable format. The plurality of decision rules corresponds to a natural language data format. Further, the term ‘natural language data format’ may refer to a representation of data expressed in human-readable linguistic form. Further, the natural language data format may include for example, but not limited to, sentences, phrases, or condition-action statements, as opposed to structured or machine-executable code formats. Further, the computer implemented system 102 may be configured to transform the extracted plurality of decision rules into a graph-based decision structure. Further, the term ‘graph-based decision structure’ may refer to a structured representation of decision logic in the form of a graph including a plurality of nodes and edges. The plurality of nodes may represent decision elements including coverage conditions or outcomes, and the edges represent logical relationships or evaluation flow between the nodes for processing an insurance claim. The graph-based decision structure may include a decision tree with a plurality of nodes and a plurality of edges. Each node may represent a respective coverage condition obtained from the plurality of insurance policy documents. Further, the computer implemented system 102 may be configured to generate an initial result for the insurance claim by evaluating the decision tree using a second Gen AI model. Further, the term ‘second Generative Artificial Intelligence (Gen AI) model’ as used herein may refer to the artificial intelligence model configured to evaluate the graph-based decision structure by processing claim-related data and coverage conditions to generate an adjudication result for an insurance claim. Further, the computer implemented system 102 may be configured to generate a stepwise reasoning path corresponding to a traversal of the decision tree using a third Gen AI model based on the generated initial result. Further, the term ‘stepwise reasoning path’ as used herein may refer to an ordered sequence of intermediate reasoning steps corresponding to evaluation of nodes in the graph-based decision structure. Each step may include an explanation of a decision made based on coverage conditions and claim-related data. Further, the term ‘third Generative Artificial Intelligence (Gen AI) model’ as used herein may refer to an artificial intelligence model configured to generate explanatory reasoning outputs, including the stepwise reasoning path, based on evaluation of the graph-based decision structure and the adjudication result. The third Gen AI model may correspond to a chain-of-thought reasoning model. Further, the term ‘chain-of-thought reasoning model’ as used herein may refer to an artificial intelligence model configured to generate a sequence of intermediate reasoning steps that collectively represent a logical progression from input data to a final decision outcome. Each intermediate step may correspond to an explanation of a respective evaluation within a decision process. Further, the computer implemented system 102 may be configured to validate at least one of diagnosis codes, procedure codes, claimant attributes, and coverage conditions corresponding to the plurality of nodes of the decision tree by querying a pre-determined domain-specific knowledge graph. Further, the term ‘diagnosis codes’ as used herein may refer to standardized alphanumeric codes representing medical diagnoses associated with a claimant, used for identifying diseases, conditions, or symptoms in an insurance claim, for example, but not limited to codes defined under ICD standards. Further, the term ‘procedure codes’ as used herein may refer to standardized alphanumeric codes representing medical procedures, treatments, or services performed for the claimant, used for billing and adjudication purposes, for example, but not limited to CPT codes or HCPCS codes. Further, the term ‘claimant attributes’ as used herein may refer to data elements associated with the claimant, including demographic information, policy-related details, medical history indicators, and eligibility-related parameters relevant to insurance claim evaluation, for example, but not limited to age, gender, policy coverage limits, prior claims, and medical conditions. Further, the term ‘coverage conditions’ as used herein may refer to policy-defined criteria, constraints, or requirements that determine eligibility, inclusion, exclusion, or reimbursement of services under an insurance policy, for example, but not limited to eligibility criteria, prior authorization requirements, exclusions, treatment limitations, and reimbursement conditions. Further, the computer implemented system 102 may be configured to the pre-determined domain-specific knowledge graph. Further, the term ‘pre-determined domain-specific knowledge graph’ may refer to a structured representation of entities and relationships within an insurance domain, configured prior to claim adjudication. The knowledge graph encodes relationships among policy rules, diagnosis codes, procedure codes, claimant attributes, and coverage conditions, for example, but not limited to dependencies, eligibility constraints, and hierarchical policy relationships. The pre-determined domain-specific knowledge graph may include relationships among the plurality of decision rules. Further, the computer implemented system 102 may be configured to the detect at least one of an inconsistency in the coverage conditions and missing supporting claim data based on the generated stepwise reasoning path, results of validation and the pre-determined domain-specific knowledge graph. Further, the term ‘at least one of an inconsistency’ as used herein may refer to the presence of one or more discrepancies identified during processing of an insurance claim. The discrepancies indicate a deviation between expected and actual evaluation outcomes, for example, but not limited to inconsistencies in application of coverage conditions, contradictions with policy rules, or mismatches with relationships defined in a domain-specific knowledge graph. Further, the computer implemented system 102 may be configured to generate structured feedback for the insurance claim using the third Gen AI model. The term ‘third Generative Artificial Intelligence (Gen AI) model’ may refer to an artificial intelligence model configured to generate reasoning and explanation outputs based on evaluation of a graph-based decision structure, for example, but not limited to generating a stepwise reasoning path, identifying inconsistencies, and producing structured feedback associated with an insurance claim adjudication process. Further, the term ‘structured feedback’ may refer to a formatted set of outputs generated for an insurance claim. The outputs may be organized according to predefined fields or attributes, for example, but not limited to a node identifier, an issue type, a re-evaluation instruction, specification of additional claim data to be retrieved, and a priority level associated with re-evaluation. The structured feedback may indicate a subset of nodes requiring re-evaluation and subsequent relevant claim data to be retrieved;
generate a final adjudication result by fine-tuning the traversal of the decision tree and updating the initial result using the second Gen AI model based on the structured feedback. Further, the term ‘subset of nodes’ as used herein may refer to one or more selected nodes from a plurality of nodes of a graph-based decision structure. The selected nodes may be identified based on predefined criteria, for example, but not limited to association with inconsistencies, missing claim data, or conditions requiring re-evaluation. Further, the computer implemented system 102 may be configured to the output the final result and an explanation data for the final result on a user interface of a user device 118A-N. Further, the explanation data may include the final result and references to at least a subset of the insurance policy documents and corresponding nodes of the decision tree associated with the final adjudication result. Further, the term ‘explanation data’ as used herein may refer to information generated to describe or justify an adjudication result. The information corresponds to reasoning steps, evaluated conditions, supporting evidence, and decision outcomes associated with processing of an insurance claim, for example, but not limited to a stepwise reasoning path, node-level decisions, and references to policy provisions.

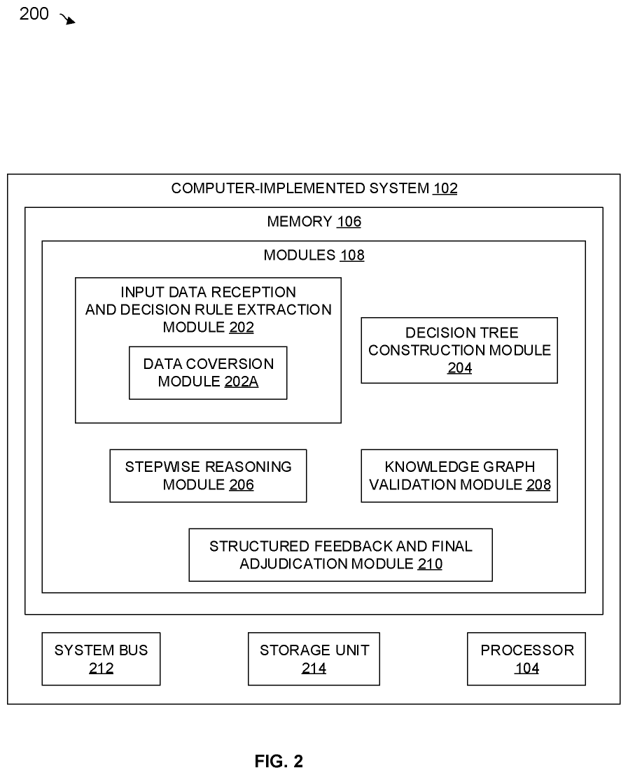

FIG. 2 illustrates an example block diagram representation of the computer implemented system 102, as shown in FIG. 1, for processing insurance claims using agentic Artificial Intelligence (AI) models, in accordance with an embodiment of the present disclosure.

Further, the computer implemented system 102 may include the processor 104, the memory 106, a system bus 212, a storage unit 214, and the modules 108. Furthermore, the modules 108 may include an input data reception and decision rule extraction module 202, a decision tree construction module 204, a stepwise reasoning module 206, a knowledge graph validation module 208, and a structured feedback and final adjudication module 210.

Further, the system bus 212 may operably connect the processor 104, the memory 106, the storage unit 214, and the modules 108 to enable communication among each of the foregoing components of the computer implemented system 102. In an example embodiment, the system bus 212 may be a peripheral component interconnect bus, a universal serial bus, a system management bus, or any suitable high-speed communication bus. Furthermore, the processor 104 may communicate with the memory 106 through the system bus 212 to access and execute processor-executable instructions stored therein.

Further, the storage unit 214 may store data corresponding to insurance claims, claimant history records, insurance policy documents, decision rules, graph-based decision structures, stepwise reasoning paths, knowledge graph validation results, structured feedback records, and final adjudication results generated during operations of the computer environment 100. In an example embodiment, the storage unit 214 may be a solid-state drive, a hard disk drive, a removable media drive, or any non-transitory computer-readable storage medium. Furthermore, the storage unit 214 may remain in communication with the processor 104 and the memory 106 via the system bus 212 to support read and write operations performed by the modules 108.

Further, the input data reception and decision rule extraction module 202 may receive input data corresponding to a health insurance claim from at least one user device 118A-N via the network 112. Furthermore, the input data may include an insurance claim, claimant history data, and a plurality of insurance policy documents retrieved from at least one policy document database among the data sources 114A-N.

In an embodiment, an interaction protocol may be defined for communication between one or more modules using gRPC bidirectional streaming. The protocol interface may be configured to support ClaimQuery and Claim Response message exchanges. The interaction protocol may limit a maximum number of queries to 10 per decision tree traversal. Further, fallback handling parameters associated with the interaction protocol may be defined, where corresponding timeout conditions and actions may be disclosed in the below Table 1.

TABLE 1

| Failure | Timeout | | Action |
|---|---|---|---|
| Retrieval | >3 | s | Cache stale data |
| LLM | >10 | s | Switch to BERT fallback |
| Network | >5 | s | Flag for manual + queue retry |

Further, a policy document database among the data sources 114A-N may serve as a structured repository storing comprehensive insurance policy documents. Furthermore, the insurance policy documents may include, for example, but not limited to, detailed rules, guidelines, eligibility criteria, coverage exclusions, treatment limitations, and reimbursement conditions governing medical treatments and insurance reimbursements. The policy document database may enable quick retrieval and interpretation of coverage conditions by organizing insurance policy document information in a structured format, ensuring that insurance claim processing aligns with predefined policy terms. Furthermore, the input data reception and decision rule extraction module 202 may integrate with one or more third-party insurance systems via the API 110 to enable seamless data exchange and interoperability between different insurance platforms.

Further, the input data reception and decision rule extraction module 202 may identify one or more relevant sections of the plurality of insurance policy documents by performing a semantic search using one or more vector embeddings of the plurality of insurance policy documents and embeddings of a claim type, diagnosis codes, and procedure codes extracted from the received input data. Furthermore, the input data reception and decision rule extraction module 202 may generate one or more prompts for the received input data using the first Generative Artificial Intelligence (Gen AI) model. The one or more prompts may include the identified one or more relevant sections and the received input data.

Further, the input data reception and decision rule extraction module 202 may identify coverage conditions as natural language condition-action pairs by processing the generated one or more prompts using the first Gen AI model. Furthermore, the coverage conditions may include eligibility criteria, prior authorization requirements, coverage exclusions, treatment limitations, and reimbursement conditions.

Further, the input data reception and decision rule extraction module 202 may generate natural language responses to the one or more prompts by applying the one or more prompts to the first Gen AI model. Furthermore, the input data reception and decision rule extraction module 202 may identify condition phrases and corresponding action phrases by parsing the generated natural language responses using a regular expressions model and a rule-based post-processing model.

Further, the input data reception and decision rule extraction module 202 may validate the condition phrases and the corresponding action phrases based on a predefined ontology model. Furthermore, the input data reception and decision rule extraction module 202 may embed the validated condition phrases and the corresponding action phrases into a plurality of decision rules. The plurality of decision rules may include rule identifiers, source policy sections, natural language conditions, and natural language actions. Further, the input data reception and decision rule extraction module 202 may include a data conversion module 202A. Further, the data conversion module 202A may be configured to convert unstructured insurance policy documents into machine-readable decision rules using the first Gen AI model. Furthermore, the unstructured insurance policy documents may include at least one of scanned portable document formats (PDFs) and text-heavy reports received from the data sources 114A-N. The input data reception and decision rule extraction module 202 may include at least one of a Generative Pre-trained Transformer (GPT) model and a Bidirectional Encoder Representations from Transformers (BERT) model, fine-tuned for insurance document interpretation, to extract and convert the unstructured insurance policy documents into the plurality of decision rules. Furthermore, the data conversion module 202A may enhance decision-making accuracy by ensuring that all extracted decision rules adhere to predefined coverage terms prior to transformation into the graph-based decision structure by the decision tree construction module 204.

In an embodiment, the input data reception and decision rule extraction module 202 may employ a text-embedding-3-small embedding model from OpenAI with a dimension of 1536 and L2 normalization using cosine similarity to generate vector embeddings of the received insurance claims and insurance policy documents.

Further, the input data reception and decision rule extraction module 202 may employ a Pinecone Serverless vector database with a pod-based index achieving a 95th percentile latency of less than 50 milliseconds for retrieval of relevant claim information from the data sources 114A-N. Furthermore, the Pinecone Serverless vector database may employ Hierarchical Navigable Small World (HNSW) indexing with HNSW64 configuration and M=32, with metadata filtering based on at least one of a claim type and a diagnosis code.

Further, the decision tree construction module 204 may transform the extracted plurality of decision rules into a graph-based decision structure. Furthermore, the graph-based decision structure may include a decision tree with a plurality of nodes and a plurality of edges, and each node may represent a respective coverage condition obtained from the plurality of insurance policy documents.

Further, the decision tree construction module 204 may preprocess natural language conditions and natural language actions within the extracted plurality of decision rules into a standardized intermediate representation by applying at least one of a tokenization process, a syntactic parsing process, and a semantic role labelling process. Furthermore, the decision tree construction module 204 may identify one or more decision variables, conditional operators, and outcome actions associated with each of the plurality of decision rules based on the standardized intermediate representation.

Further, the decision tree construction module 204 may map the identified one or more decision variables to corresponding claim attributes using a predefined ontology model. Furthermore, the claim attributes may include at least one of the diagnosis codes, the procedure codes, claimant attributes, and policy parameters.

Further, the decision tree construction module 204 may classify each of the plurality of decision rules into one of a plurality of rule types based on the mapping. Furthermore, the plurality of rule types may include eligibility rules, exclusion rules, dependency rules, and sequencing rules.

Further, the decision tree construction module 204 may determine logical dependencies among the plurality of decision rules by analyzing at least one of shared decision variables, conditional relationships, and hierarchical policy structures. Furthermore, the decision tree construction module 204 may generate a directed graph structure by assigning each of the plurality of decision rules to a corresponding node and directed edges between nodes based on the determined logical dependencies and an evaluation order.

Further, the decision tree construction module 204 may convert the directed graph structure into the decision tree by assigning a root node corresponding to an initial eligibility condition, generating intermediate nodes corresponding to conditional evaluations, and defining leaf nodes corresponding to results. Furthermore, the results may include one of an approval, a denial, and a flagging for review.

Further, the decision tree construction module 204 may identify and fill missing data gaps by supplementing incomplete insurance claim details with relevant claim information retrieved from the data sources 114A-N via the input data reception and decision rule extraction module 202. Furthermore, the decision tree construction module 204 may evaluate variables associated with each node of the decision tree, including at least one of prior claim filing criteria, severity of diagnosis, and pre-existing conditions of the claimant. The filling of missing data gaps may be performed prior to traversal of the decision tree to maintain consistency and accuracy in the adjudication decision-making process. Furthermore, the decision tree construction module 204 may communicate with the input data reception and decision rule extraction module 202 to retrieve additional relevant claim information when required to ensure all claim data necessary for complete node evaluation has been obtained.

In an embodiment, the one or more modules may generate a node evaluation prompt template for evaluating a node of the graph-based decision structure. The node evaluation prompt template may include a node identifier {node_id}, a condition text {condition text}corresponding to the node, claim facts {facts_json}, and a history summary {history_summary}. The node evaluation prompt template may further include an evaluation instruction configured to determine whether the condition associated with the node is TRUE or FALSE, generate a confidence score within a range of 0.0 to 1.0, and produce associated reasoning for the evaluation result. In an embodiment, variable evaluation associated with the node evaluation prompt template may include evaluation of prior claims using a structured query on a history database, diagnosis severity using one or more diagnosis lookup tables, and missing data by querying one or more external interfaces. The unavailable information may be treated as insufficient evidence and flagged for further review.

Further, the stepwise reasoning module 206 may generate a stepwise reasoning path corresponding to a traversal of the decision tree using the third Gen AI model based on an initial adjudication result generated by the decision tree construction module 204. Furthermore, the third Gen AI model may correspond to the chain-of-thought reasoning model.

In an embodiment, the decision tree construction module 204 may generate a hierarchical decision tree organized across a plurality of hierarchical levels including at least one of a coarse medical category level, a procedure level, and a patient-specific level. Furthermore, the hierarchical decision tree may enable the second Generative Artificial Intelligence (AI) model to evaluate insurance claims across multiple levels of coverage conditions in a structured top-down traversal.

Further, the decision tree construction module 204 may compress the generated hierarchical decision tree into a latent embedding space using a Graph Neural Network (GNN) corresponding to a Graph SAGE architecture. Furthermore, the GNN may aggregate node-level features across the hierarchical decision tree using Graph SAGE layer-wise propagation to generate compressed node embeddings preserving coverage condition relationships encoded within the hierarchical decision tree.

Further, the GNN may optimize the compressed latent embedding using a compression loss function balancing at least one of a structural reconstruction loss and a decision fidelity loss. Furthermore, the compressed latent embedding generated by the GNN may be transmitted to the second Generative Artificial Intelligence (AI) model for traversal in place of the full hierarchical decision tree, enabling approximately 3× faster inference on complex insurance claims including transplant authorizations.

Further, the second Generative Artificial Intelligence (AI) model may traverse the compressed GNN embedding representation of the hierarchical decision tree by generating context-aware prompts incorporating the compressed node embeddings and corresponding coverage conditions at each hierarchical level. Furthermore, the GNN-compressed hierarchical decision tree traversal may enable the computer implemented system 102 to perform scalable adjudication of multi-level coverage conditions across large volumes of complex insurance claims.

Further, the stepwise reasoning module 206 may receive at least one of the initial adjudication result, intermediate decision metadata, traversal paths, and the decision tree generated by the second Gen AI model. Furthermore, the stepwise reasoning module 206 may regenerate a sequence of nodes traversed during evaluation of the decision tree based on the received initial adjudication result, the intermediate decision metadata, the traversal paths, and the decision tree.

Further, the stepwise reasoning module 206 may extract the coverage conditions, node-level decision outputs, and the claim attributes for each node in the regenerated sequence of nodes. Furthermore, the stepwise reasoning module 206 may generate a structured prompt using the third Gen AI model. The structured prompt may include the regenerated sequence of nodes, the coverage conditions, the claim attributes, and the node-level decision outputs.

Further, the stepwise reasoning module 206 may iteratively process the structured prompt using the third Gen AI model to generate a sequence of intermediate reasoning steps. Furthermore, each intermediate reasoning step may include an explanation corresponding to an evaluation of a respective node, along with references to supporting evidence from the claim data and sections of the plurality of insurance policy documents.

Further, the stepwise reasoning module 206 may validate a logical consistency within the sequence of intermediate reasoning steps to determine an alignment between the node-level decision outputs and the coverage conditions. Furthermore, the stepwise reasoning module 206 may generate the stepwise reasoning path as an ordered chain-of-thought representation based on the validated logical consistency.

Further, the knowledge graph validation module 208 may validate at least one of diagnosis codes, procedure codes, claimant attributes, and coverage conditions applied at the plurality of nodes of the decision tree by querying a pre-determined domain-specific knowledge graph. Furthermore, the pre-determined domain-specific knowledge graph may encode relationships among the plurality of decision rules extracted from the plurality of insurance policy documents. Further, the knowledge graph validation module 208 may extract validation elements from at least one of the stepwise reasoning path, the intermediate decision metadata, and the traversal paths. Furthermore, the validation elements may include the diagnosis codes, the procedure codes, the claimant attributes, the coverage conditions applied at each node, and the node-level decision outputs.

Further, the knowledge graph validation module 208 may preprocess the extracted validation elements into a standardized representation using at least one of an ontology mapping process, a code normalization process, and a semantic alignment process. Furthermore, the knowledge graph validation module 208 may generate one or more structured queries for the pre-determined domain-specific knowledge graph by mapping the pre-processed validation elements to corresponding entities and relationships encoded within the pre-determined domain-specific knowledge graph.

Further, the knowledge graph validation module 208 may execute the one or more structured queries on the pre-determined domain-specific knowledge graph to retrieve relationship data representing one or more dependencies among the plurality of decision rules, the diagnosis codes, the procedure codes, and the claimant attributes. Furthermore, the knowledge graph validation module 208 may generate one or more validation results and validation metadata indicating a validation status and corresponding conflicting relationships retrieved from the pre-determined domain-specific knowledge graph.

Further, the knowledge graph validation module 208 may continuously monitor insurance policy updates by embedding new insurance policy documents using the first Generative Artificial Intelligence (AI) model and computing a knowledge graph drift score based on Kullback-Leibler (KL) divergence on edge distributions of the pre-determined domain-specific knowledge graph. Furthermore, the knowledge graph drift score may be computed based on edge distributions of the pre-determined domain-specific knowledge graph before and after processing updated insurance policy documents.

Further, the knowledge graph validation module 208 may detect a policy drift when the computed knowledge graph drift score may exceed a predefined threshold value of 0.1. Furthermore, upon detection of policy drift, the knowledge graph validation module 208 may trigger a counterfactual augmentation process, The first Generative Artificial Intelligence (AI) model may generate one or more counterfactual claim scenarios corresponding to what-if insurance claim conditions based on the updated insurance policy documents.

Further, the counterfactual claim scenarios generated by the first Generative Artificial Intelligence (AI) model may be used to retrain the decision tree construction module 204 to extract updated decision rules reflecting the detected policy changes. Furthermore, the knowledge graph validation module 208 may simulate adjudication outcomes for the generated counterfactual claim scenarios using the second Generative Artificial Intelligence (AI) model to validate stability of the updated decision tree prior to deployment in live insurance claim adjudication processing.

Further, the structured feedback and final adjudication module 210 may detect at least one of an inconsistency in the application of coverage conditions and missing supporting claim data based on the generated stepwise reasoning path and the results of validation using the pre-determined domain-specific knowledge graph. Furthermore, the structured feedback and final adjudication module 210 may classify each detected issue as at least one of a logical inconsistency, a policy inconsistency, a data insufficiency, and an incomplete evaluation condition. Further, the structured feedback and final adjudication module 210 may generate structured feedback for the insurance claim using the third Gen AI model. Furthermore, the structured feedback may indicate a subset of nodes requiring re-evaluation and may specify additional relevant claim data to be retrieved for each node in the subset of nodes.

Further, the structured feedback and final adjudication module 210 may generate corrective reasoning instructions for each node in the subset of nodes by processing a structured prompt using the third Gen AI model. Furthermore, the structured feedback may include a node identifier, an issue type, a re-evaluation instruction, a specification of relevant claim data to be retrieved, and a priority level associated with the re-evaluation. Further, the structured feedback and final adjudication module 210 may generate a final adjudication result by refining the traversal of the decision tree and updating the initial adjudication result using the second Gen AI model based on the structured feedback. Furthermore, the structured feedback and final adjudication module 210 may selectively re-traverse the decision tree by re-evaluating the subset of nodes identified in the structured feedback using an updated contextual representation of the relevant claim data. Further, the structured feedback and final adjudication module 210 may output the final adjudication result and corresponding explanation data on a user interface of at least one of the user devices 118A-N via the network 112. Furthermore, the explanation data may reference the plurality of insurance policy documents and the plurality of nodes of the decision tree traversed during generation of the final adjudication result.

Further, the structured feedback and final adjudication module 210 may output the final adjudication result and corresponding explanation data on a user interface dashboard displayed on at least one of the user devices 118A-N via the network 112. Furthermore, the user interface dashboard may provide a comprehensive view of the adjudication decision-making workflow, displaying the stepwise reasoning path, references to specific insurance policy documents, and coverage conditions applied at each node of the decision tree traversed during generation of the final adjudication result. The user interface dashboard may allow authorized users to manually intervene in adjudication cases flagged for further review, ensuring that automated adjudication decisions may be overseen and adjusted when necessary. Furthermore, the structured feedback and final adjudication module 210 may communicate the final adjudication result to one or more insurers associated with the insurance claim in a timely and secure manner via the API 110. The structured feedback and final adjudication module 210 may additionally perform compliance checks to ensure that the adjudication process aligns with applicable regulatory requirements and organizational policies governing insurance claim processing.

In an embodiment, the structured feedback and final adjudication module 210 may generate structured feedback including symbolic proofs corresponding to first-order logic traces for each node in the subset of nodes requiring re-evaluation. Furthermore, the symbolic proofs generated by the third Generative Artificial Intelligence (AI) model may represent verifiable logical traces of coverage condition evaluations including at least one of prior authorization conditions, comorbidity conditions, and corresponding adjudication outcomes at each node of the decision tree.

Further, in an embodiment, the symbolic proofs generated by the third Generative Artificial Intelligence (AI) model may be verified against coverage condition constraints encoded within the pre-determined domain-specific knowledge graph using a Z3 Satisfiability Modulo Theories (SMT) solver integrated with the knowledge graph validation module 208. Furthermore, the Z3 SMT solver may evaluate the logical consistency of each symbolic proof against the relationships and constraints encoded within the pre-determined domain-specific knowledge graph to determine whether the symbolic proof may be accepted or rejected.

Further, in an embodiment, the structured feedback and final adjudication module 210 may reject symbolic proofs identified as inconsistent by the Z3 SMT solver and may request regeneration of corrective reasoning instructions for the corresponding nodes by the third Generative Artificial Intelligence (AI) model. Furthermore, the neuro-symbolic verification loop performed by the structured feedback and final adjudication module 210 and the Z3 SMT solver may boost explainability and auditability of the final adjudication result generated by the computer implemented system 102.

In an embodiment, the computer-implemented system 102 may be configured to extract the plurality of decision rules corresponding to the received input data. Further, the processor 104 may be configured to identify one or more relevant sections of the plurality of insurance policy documents by performing a semantic search using one or more vector embeddings of the plurality of insurance policy documents and embeddings of a claim type, the diagnosis codes, and the procedure codes from the input data. Further, the term “semantic search” may refer to a computer-implemented process for retrieving information based on the meaning or context of a query rather than exact keyword matches. The process may include generating vector embeddings of text data, determining similarity between embeddings, and identifying content semantically related to the query. The semantic search may be applied to insurance policy documents, claim data, or other relevant data sources. Further, the term one or more vector embeddings may refer to numerical representations of textual data in a high-dimensional vector space. Each embedding encodes semantic or contextual information of the text. The one or more vector embeddings may be used to determine similarity, relevance, or relationships between queries and content in applications such as semantic search, document retrieval, or decision rule extraction. Further, the term “Claim type” may refer to a category or classification of the insurance claim based on the nature of the requested coverage, the medical procedure, or the policy under which the claim is submitted, and may include, for example, but not limited to, inpatient claim, outpatient claim, surgical claim, or diagnostic claim. Further, the term “diagnosis codes” may refer to standardized alphanumeric or numeric codes assigned to medical conditions or diseases associated with the insurance claim, such as ICD (International Classification of Diseases) codes, which identify the patient's diagnosis for the purpose of determining coverage and reimbursement. Further, the term “procedure codes” may refer to standardized alphanumeric or numeric codes assigned to medical procedures, treatments, or services performed on a patient corresponding to the insurance claim, such as CPT (Current Procedural Terminology) codes or HCPCS (Healthcare Common Procedure Coding System) codes, which may be used to identify and validate services for claim adjudication and reimbursement. Further, the processor 104 may be configured generate one or more prompts for the input data using the first generative AI model. The one or more prompts may include the identified one or more relevant sections and the input data. Further, the term “one or more relevant sections” may refer to portions, excerpts, or segments of one or more documents, including insurance policy documents, that contain information pertinent to a particular insurance claim, claim type, diagnosis code, or procedure code, and that may be identified for processing, analysis, or extraction of decision rules. Further, the term “one or more prompts” may refer to one or more computer-generated or user-generated instructions, queries, or inputs provided to a generative artificial intelligence model. The one or more prompts may include at least a portion of the input data and/or the identified one or more relevant sections. The one or more prompts may be configured to elicit natural language responses, reasoning steps, or decision outputs from the generative AI model. Further, the processor 104 may be configured to identify the coverage conditions as natural language condition-action pairs by processing the generated one or more prompts using the first generative AI model. The coverage conditions may include an eligibility criteria, prior authorization requirements, coverage exclusions, treatment limitations, and reimbursement conditions. Further, the term “coverage conditions” may refer to natural language condition action pairs extracted from insurance policy documents that specify the circumstances under which a claim is eligible, excluded, limited, or reimbursed. Further, the processor 104 may be configured to generate natural language responses to the one or more prompts by applying the one or more prompts to the first Gen AI model. Further, the processor 104 may be configured to identify condition phrases and corresponding action phrases by parsing the generated natural language responses using regular expressions model and rule-based post-processing model. Further, the term “regular expressions model” may refer to a pattern-matching mechanism used to identify, extract, or validate specific phrases within natural language data. The regular expressions mode may include for example, but not limited to, a regular expressions model may detect condition phrases such as “prior authorization required” or action phrases such as “claim denied if missing documentation”. Further, the term “rule-based post-processing model” may refer to a deterministic framework that applies predefined logical rules to refine or adjust outputs generated by an AI model or parsing process. Further, the processor 104 may be configured to validate the condition phrases and the corresponding action phrases based on a predefined ontology model. Further, the term “predefined ontology model” may refer to a structured representation of concepts, entities, and relationships that is established prior to system execution and used to ensure consistency in interpreting claim attributes, coverage conditions, and decision rules. Further, the predefined ontology model may include for example, but not limited to, a predefined ontology model may include mappings between diagnosis codes and medical procedures, hierarchical relationships among insurance policy parameters, or standardized categories for claimant attributes. Further, the processor 104 may be configured to embed the condition phrases and the corresponding action phrases into the plurality of decision rules. The plurality of decision rules may include rule identifiers, source policy sections, natural language conditions, and natural language actions.

In an embodiment, semantic matching may be performed using cosine similarity computed over one or more vector embeddings in combination with a large language model (LLM)-based normalization mechanism. The cosine similarity may be evaluated against predefined thresholds, as specified in the corresponding table, to determine a match type. Based on the determined match type, the LLM may further validate and normalize an input term to a semantically corresponding term. The output may include a normalized term or a matched term generated based on the semantic similarity and the LLM-based validation. The below Table. 2 provides predefined cosine similarity thresholds corresponding to respective match types.

TABLE 2

| Match Type | Cosine Threshold |
|---|---|
| Exact | >0.95 |
| Semantic | >0.85 |
| Weak (prompt LLM) | 0.70-0.85 |

In an embodiment, the computer-implemented system 102 may be configured to transform the extracted plurality of decision rules into the graph-based decision structure. Further, the processor 104 may be configured to preprocess natural language conditions and natural language actions within the extracted plurality of decision rules into a standardized intermediate representation by applying at least one of a tokenization process, a syntactic parsing process, and a semantic role labelling process on the extracted plurality of decision rules. Further, the term “standardized intermediate representation” may refer to a normalized format used to convert natural language conditions and actions into a consistent structure that can be further processed into decision rules or graph-based models. Further, the term “syntactic parsing process” may refer to the analysis of natural language text to determine its grammatical structure and relationships among words. Further, the term “semantic role labelling process” may refer to the annotation of natural language text with labels that indicate the roles played by words or phrases in expressing meaning. Further, the term “tokenization process” may refer to the operation of segmenting natural language text into smaller units called tokens, which may represent words, phrases, or symbols. Further, the term “syntactic parsing process” may refer to the analysis of natural language text to determine its grammatical structure and relationships among words. Further, the processor 104 may be configured to identify one or more decision variables, conditional operators, and outcome actions associated with each of the plurality of decision rules based on the standardized intermediate representation. Further, the processor 104 may be configured to map the identified one or more decision variables to corresponding claim attributes using a predefined ontology model. The claim attributes may include at least one of the diagnosis codes, the procedure codes, the claimant attributes, and policy parameters. Further, the processor 104 may be configured to classify each of the plurality of decision rules into one of a plurality of rule types based on the mapping. The plurality of rule types may include eligibility rules, exclusion rules, dependency rules, and sequencing rules. Further, the term “a plurality of rule types” may refer to different categories of decision rules that may be classified based on their function within a decision structure. Further, the processor 104 may be configured to determine logical dependencies among the plurality of decision rules by analyzing at least one of shared decision variables, conditional relationships, and hierarchical policy structures. Further, the term “shared decision variables” may refer to claim attributes or policy parameters that may be used across multiple decision rules within a decision structure. Further, the term “conditional relationships” may refer to logical connections among decision rules that determine how the evaluation of one condition influences the evaluation of another. Further, the term “hierarchical policy structures” may refer to layered or ranked arrangements of insurance policy rules that establish precedence or priority among conditions. Further, the processor 104 may be configured to generate a directed graph structure by assigning each of the plurality of decision rules to a corresponding node and directed edges between nodes based on the determined logical dependencies and an evaluation order. Further, the term “directed graph structure” may refer to a representation of interconnected nodes where each edge has a defined direction, indicating the flow of evaluation or dependency between decision rules. Further, the processor 104 may be configured to convert the directed graph structure into the decision tree by assigning a root node corresponding to an initial eligibility condition, generating intermediate nodes corresponding to conditional evaluations, and defining leaf nodes corresponding to results. The results may include one of an approval, a denial, and flagging for review. Further, the term “root node” may refer to the starting point of the graph-based decision structure or decision tree, from which all subsequent evaluations and traversal paths originate. Further, the term “initial eligibility condition” may refer to the first coverage requirement evaluated in a decision tree to determine whether a claim qualifies for further processing. Further, the processor 104 may be configured to encode a corresponding evaluation function for each node based on the decision tree. The corresponding evaluation function may include the coverage condition, the claim attributes, and decision thresholds obtained from the plurality of insurance policy documents. Further, the processor 104 may be configured to determine overlapping decision rules by applying at least one of a priority ranking, a rule weighting, and conflict resolution heuristics to the decision tree based on a policy hierarchy and a rule specificity. Further, the term “priority ranking” may refer to an ordered arrangement of decision rules based on their relative importance or precedence within a policy hierarchy. Further, the term “rule weighting” may refer to the assignment of numerical or categorical values to decision rules to indicate their relative influence during evaluation. Further, the processor 104 may be configured to validate a structural consistency of the decision tree by determining completeness of the corresponding evaluation function, absence of cyclic dependencies, and coverage of relevant policy conditions. Further, the processor 104 may be configured generate the decision tree in a machine-readable format based on the validated structural consistency of the decision tree. Further, the term “machine-readable format” may refer to a structured representation of data or instructions that can be directly processed by a computer system without requiring manual interpretation.

In an embodiment, the computer-implemented system 102 may be configured to generate the initial result for the insurance claim by evaluating the decision tree using the second Gen AI model. Further, the processor 104 may be configured to initialize a traversal process at a root node of the decision tree corresponding to an initial coverage condition. Further, the term “traversal process” may refer to the systematic progression through nodes of the decision tree or graph-based decision structure to evaluate coverage conditions and determine outcomes. Further, the term “initial coverage condition” may refer to the first policy requirement or eligibility check applied to an insurance claim during evaluation of a decision tree. Further, the processor 104 may be configured to generate a contextual representation of the relevant claim data using the second generative AI model by encoding at least one of the insurance claim, claimant history data, and policy-related attributes. Further, the processor 104 may be configured to traverse the decision tree by iteratively evaluating the plurality of nodes using the second generative AI model until a terminal node corresponding to a result is reached. Further, the term “terminal node” may refer to the endpoint of a decision tree or graph-based decision structure, representing a final adjudication outcome with no further traversal paths. Further, the processor 104 may be configured to generate a reasoning sequence associated with the insurance claim by aggregating node-level decision outputs generated across the traversal. Further, the term “node-level decision outputs” may refer to the results generated at individual nodes within a decision tree or graph-based decision structure, reflecting the evaluation of a specific coverage condition or rule. Further, the processor 104 may be configured to determine the initial result based on the result associated with the terminal node. Further, the processor 104 may be configured to generate intermediate decision metadata may include at least one of traversal paths, evaluated coverage conditions, retrieved claim data, and the node-level decision outputs. Further, the processor 104 may be configured to iteratively evaluate the plurality of nodes using the second generative AI model. Further, the processor 104 may be configured to: retrieve a corresponding evaluation function for each node detected during traversal of the decision tree. The corresponding evaluation function may include the coverage condition, the claim attributes, and a decision criteria. Further, the term “decision criteria” may refer to the set of parameters, conditions, or standards used to evaluate and determine the outcome of a claim or policy decision. Further, the processor 104 may be configured to generate a context-aware prompt using the second generative AI model. The context-aware prompt may include the coverage condition, the claim attributes, and the contextual representation of the relevant claim data. Further, the term “context-aware prompt” may refer to an input instruction designed for the natural language processing system that incorporates surrounding information, prior outputs, or domain-specific knowledge to guide the generation of accurate and relevant responses. Further, the processor 104 may be configured to generate the node-level decision output by evaluating the coverage condition with the relevant claim data using the generated context-aware prompt. The node-level decision output may indicate one of a satisfaction of the coverage condition and a non-satisfaction of the coverage condition.

In an embodiment, the computer-implemented system 102 may be configured to generate the stepwise reasoning path corresponding to the traversal of the decision tree using the third Gen AI model based on the generated initial result. Further, the processor 104 may be configured to receive at least one of the initial result, intermediate decision metadata, traversal paths, and the decision tree generated by the second generative AI model. Further, the processor 104 may be configured to regenerate a sequence of nodes traversed during evaluation of the decision tree based on the received initial result, the intermediate decision metadata, the traversal paths, and the decision tree. The sequence of nodes may include an order of evaluation of the plurality of nodes. The term “sequence of nodes” may refer to an ordered arrangement of nodes within a decision tree or graph-based decision structure, representing the progression of evaluations applied to coverage conditions or policy rules. Further, the processor 104 may be configured to extract the coverage conditions, node-level decision outputs, and the claim attributes for each node in the regenerated sequence of nodes. Further, the processor 104 may be configured to generate a structured prompt using the third generative AI model. The structured prompt may include the regenerated sequence of nodes, the coverage conditions, the claim attributes, and the node-level decision outputs. Further, the term “structured prompt” may refer to a formatted input instruction that follows a predefined schema or template to guide a natural language processing system in generating consistent and reliable outputs. Further, the processor 104 may be configured to iteratively process the structured prompt using the third generative AI model to generate a sequence of intermediate reasoning steps. Each intermediate reasoning step may include an explanation to an evaluation of a respective node. Further, the processor 104 may be configured to generate a node-aligned reasoning sequence by mapping each intermediate reasoning step with a corresponding node in the decision tree. The intermediate reasoning step may include references to supporting evidence from the claim data and sections in the plurality of insurance policy documents. Further, the term “node-aligned reasoning sequence” may refer to an ordered progression of logical evaluations that directly correspond to nodes within a decision tree or graph-based decision structure. Further, the processor 104 may be configured to validate a logical consistency within the sequence of the intermediate reasoning steps to determine an alignment between the node-level decision outputs and the coverage conditions. Further, the processor 104 may be configured to generate the stepwise reasoning path as an ordered chain-of-thought representation based on the validated logical consistency. The stepwise reasoning path may include the sequence of intermediate reasoning steps corresponding to the traversal of the decision tree.

In an embodiment, the one or more modules may utilize a chain-of-thought large language model (CoT LLM) configured with an inference temperature of 0.1 and a maximum token limit of 2048 for reviewing traversal of the decision tree in a stepwise manner. The CoT LLM may process a tree path, corresponding claim facts, and one or more policy conditions, and may sequentially verify whether a first node condition is met, determine whether a subsequent node has been correctly evaluated, and assess whether available evidence is sufficient for adjudication. Based on the stepwise review, the CoT LLM may generate feedback data in a structured JSON format ({feedback_json}), the feedback data including at least an error type, a node identifier, associated reasoning, a suggested action, and a confidence score.

In an embodiment, the one or more modules may further utilize a knowledge graph database including PolicyRule, ClaimFact, and CoverageCondition nodes interconnected through relationships including REQUIRES_PRIOR_AUTH, EXCLUDES_IF, and DEPENDS_ON_LAB. The knowledge graph may be constructed based on large language model parsing in combination with rule-based extraction for CPT and ICD information and may be queried during node evaluation to validate policy exclusions and dependency conditions associated with one or more diagnosis codes or claim facts. The knowledge graph may be updated through daily incremental updates for new policies and quarterly full retraining. Further, the stepwise review and feedback generation may be iteratively performed for a maximum of three iterations, and convergence may be determined when no new errors may be identified.

In an embodiment, the computer-implemented system 102 may be configured to validate the at least one of the diagnosis codes, the procedure codes, the claimant attributes, and the coverage conditions corresponding to the plurality of nodes of the decision tree. Further, the processor 104 may be configured to extract validation elements from the at least one of the stepwise reasoning path, the intermediate decision metadata, and the traversal paths. The validation elements may include the diagnosis codes, the procedure codes, the claimant attributes, the coverage conditions applied at each node, and the node-level decision outputs. Further, the processor 104 may be configured to preprocess the extracted validation elements into a standardized representation using at least one of an ontology mapping process, a code normalization process, and a semantic alignment process. Further, the term “ontology mapping process” may refer to the alignment of concepts, terms, or entities across different ontologies or knowledge representations to ensure semantic consistency. Further, the term “code normalization process” may refer to the transformation of codes or identifiers into a standardized representation to reduce variation and improve comparability. Furthermore, the term “semantic alignment process” may refer to the reconciliation of meaning across different data sources, models, or rule sets to ensure that terms and conditions may be interpreted consistently. Further, the processor 104 may be configured to generate one or more structured queries for the pre-determined domain-specific knowledge graph by mapping the preprocessed validation elements to corresponding entities and relationships encoded within the pre-determined domain-specific knowledge graph. Each query corresponds to a validation check associated with at least one node of the decision tree. Furthermore, the term “one or more structured queries” may refer to formalized requests expressed in a standardized query language or schema that retrieve, filter, or evaluate information from a database, knowledge base, or decision structure. Further, the processor 104 may be configured to execute the one or more structured queries on the pre-determined domain-specific knowledge graph to retrieve relationship data representing one or more dependencies among the plurality of insurance policy rules, the diagnosis codes, the procedure codes, and the claimant attributes. Further, the processor 104 may be configured to determine whether the coverage conditions may be consistent with the relationships encoded in the pre-determined domain-specific knowledge graph by comparing the retrieved relationship data with the coverage conditions applied at the plurality of nodes. Further, the processor 104 may be configured to evaluate whether the diagnosis codes and the procedure codes satisfy policy-defined eligibility constraints, the claimant attributes comply with policy-specific conditions, and the coverage conditions reflect the dependencies among the extracted validation elements. Further, the processor 104 may be configured to generate one or more validation results may include at least one of consistency of the coverage conditions, inconsistency between the coverage conditions and knowledge graph relationships, and absence of required relationships in the pre-determined domain-specific knowledge graph. Further, the processor 104 may be configured to generate validation metadata indicating a validation status and corresponding conflicting relationships retrieved from the pre-determined domain-specific knowledge graph.

In an embodiment, the computer-implemented system 102 may be configured to detect the at least one of the inconsistencies in the coverage conditions and the missing supporting claim data based on the generated stepwise reasoning path, the results of validation and the pre-determined domain-specific knowledge graph. Further, the processor 104 may be configured to receive at least one of the stepwise reasoning path, the validation metadata, the intermediate decision metadata, and the traversal paths associated with evaluation of the decision tree. Further, the processor 104 may be configured to extract one or more comparison elements from the received information. The one or more comparison elements may include the node-level decision outputs, the coverage conditions applied at each node, the claim attributes, the diagnosis codes, the procedure codes, and the results of validation obtained from the pre-determined domain-specific knowledge graph. Further, the term “one or more comparison elements” may refer to specific parameters, attributes, or values used to evaluate differences or similarities between decision rules, coverage conditions, or adjudication outcomes. Further, the processor 104 may be configured to align the comparison elements for each node by correlating the node-level decision outputs with the coverage conditions and the results of validation. Further, the processor 104 may be configured to determine an expected outcome based on the relationships retrieved from the pre-determined domain-specific knowledge graph and the claim attributes. Further, the processor 104 may be configured to compare the node-level decision outputs with the expected outcomes to identify discrepancies between the coverage conditions and the relationships defined in the pre-determined domain-specific knowledge graph. Further, the processor 104 may be configured to detect one or more issues in the generated stepwise reasoning path and the results of validation. The one or more issues include at least one of an absence of required claim attributes, the diagnosis codes, and the procedure codes associated with the coverage condition, a presence of unsupported stepwise reasoning path references, and an absence of required dependencies. Further, the processor 104 may be configured to classify each detected issue as at least one of a logical inconsistency, a policy inconsistency, a data insufficiency, and an incomplete evaluation condition. Further, the term “logical inconsistency” may refer to a contradiction or conflict within a reasoning path or decision sequence that prevents coherent evaluation. Further, the term “policy inconsistency” may refer to a misalignment or contradiction between adjudication rules and the governing policy framework. Further, the term “data insufficiency” may refer to the absence or incompleteness of required information needed to evaluate a claim or coverage condition. Further, the term “incomplete evaluation condition” may refer to a partially defined or unresolved requirement within a decision tree that prevents full adjudication. Further, the processor 104 may be configured to generate inconsistency metadata for each detected issue. The inconsistency metadata may include at least one of an identifier of the corresponding node, a type of inconsistency, missing information, a description of the discrepancy, and a reference to the coverage condition and the results of validation.

In an embodiment, the computer-implemented system 102 may be configured to generate the structured feedback for the insurance claim using the third Gen AI model. Further, the processor 104 may be configured to identify a subset of nodes of the decision tree associated with detected inconsistencies and missing supporting claim data based on the stepwise reasoning path, the inconsistency metadata, the validation metadata, the intermediate decision metadata, and the traversal paths associated with evaluation of the decision tree. Further, the processor 104 may be configured to classify an issue type for each node in the subset of nodes. The issue type may include at least one of a logical inconsistency, a policy inconsistency, a data insufficiency, and an incomplete evaluation condition. Further, the processor 104 may be configured to extract the coverage conditions, node-level decision outputs, the claim attributes, and the results of validation for each node in the subset of nodes. Further, the processor 104 may be configured to generate a structured prompt using the third generative AI model. The structured prompt may include the identified subset of nodes, the issue type, the coverage conditions, the node-level decision outputs, and the results of validation. Further, the processor 104 may be configured to generate corrective reasoning instructions for each node in the subset of nodes by processing the structured prompt using the third generative AI model. Further, the processor 104 may be configured to determine one or more re-evaluation actions based on the corrective reasoning instructions. The one or more re-evaluation actions may include re-evaluating the coverage condition, modifying a decision threshold, revisiting a traversal path, and requesting supporting data. Further, the processor 104 may be configured to identify relevant claim data required to resolve the detected issue for each node requiring re-evaluation. The relevant claim data may include at least one of missing diagnosis codes, missing procedure codes, incomplete claimant attributes, and absent supporting documentation. Further, the processor 104 may be configured to generate the structured feedback for each node in the subset of nodes. The structured feedback may include a node identifier, the issue type, a re-evaluation instruction, a specification of the relevant claim data to be retrieved, and a priority level associated with the re-evaluation.

In an embodiment, the computer-implemented system 102 may be configured to generate the final result by refining the traversal of the decision tree and updating the initial result using the second generative artificial intelligence (AI) model based on the structured feedback. Further, the processor 104 may be configured to identify the subset of nodes requiring re-evaluation and corresponding re-evaluation instructions based on the structured feedback. Further, the processor 104 may be configured to retrieve subsequent relevant claim data specified in the structured feedback from at least one of a data retrieval subsystem, external data sources, and the input data. Further, the processor 104 may be configured to update the contextual representation of the relevant claim data based on the retrieved subsequent claim data. Further, the processor 104 may be configured to selectively re-traverse the decision tree by re-evaluating the subset of nodes identified in the structured feedback. Further, the processor 104 may be configured to reconstruct a node-specific evaluation context for each node in the subset of nodes. The node-specific evaluation context may include the updated claim data and the coverage condition. Further, the term “node-specific evaluation context” may refer to the localized set of parameters, attributes, and conditions applied at a particular node within a decision tree or graph-based structure to guide its evaluation. Further, the processor 104 may be configured to generate a revised context-aware prompt using the second generative AI model. Further, the processor 104 may be configured to generate an updated node-level decision output by re-evaluating the coverage condition. Further, the term “updated node-level decision output” may refer to a revised or modified result generated at an individual node within the decision tree or graph-based decision structure, reflecting changes in evaluation context, claim attributes, or applied rules. Further, the processor 104 may be configured to generate an updated result as the final adjudication result by recomputing a traversal path based on the updated node-level decision output.

In an embodiment, the processor 104 may be configured to perform federated fine-tuning of the first generative AI model, the second generative AI model, and the third generative AI model corresponding to a plurality of insurance systems using a secure multi-party computation model. Further, the processor 104 may be configured to perform a quantum-inspired routing of the insurance claim to an optimal combination of the first generative AI model, the second generative AI model, and the third generative AI model. Further, the processor 104 may be configured to perform a self-healing of multiple parallel processing ensembles of the first generative AI model, the second generative AI model, and the third generative AI model using a Bayesian uncertainty quantification model. Further, the term “self-healing of multiple parallel processing” may refer to the automated detection and correction of faults, errors, or inefficiencies occurring across concurrent computational tasks. Further, the term “Bayesian uncertainty quantification model” may refer to a probabilistic framework that applies Bayesian inference to estimate and represent uncertainty in computational predictions or decision outcomes. Further, the processor 104 may be configured to generate the final result referencing the plurality of insurance policy documents and the plurality of nodes of the decision tree based on the performed federated fine-tuning, the quantum-inspired routing and the self-healing process.

In an embodiment, the computer-implemented system 102 may be configured to perform the fine-tuning of the first generative AI model, the second generative AI model, and the third generative AI model. Further, the processor 104 may be configured to fine-tune the first generative AI model, the second generative AI model, and the third generative AI model locally at each of the insurance systems using a specific training data including insurance claims and the plurality of policy documents. Further, the processor 104 may be configured to compute one or more gradient update values based on the fine-tuned first generative AI model, the fine-tuned second generative AI model, and the fine-tuned third generative AI model. Further, the processor 104 may be configured to generate a global model update value by federally aggregating the computed one or more gradient update values for each of the plurality of insurance systems using the secure multi-party computation model.

In an embodiment, the computer-implemented system 102 may be configured to perform the quantum-inspired routing of the insurance claim to the optimal combination of the first generative AI model, the second generative AI model, and the third generative AI model. Further, the processor 104 may be configured to determine a cost function value. The cost function value. may include at least one of the decision tree depth, claim risk factors, and a historical model performance for a plurality of combinations of the first generative AI model, the second generative AI model, and the third generative AI model. The claim risk factors may include a billed amount, a procedure complexity, and claimant health attributes. Further, the processor 104 may be configured to select an optimal model combination by applying a simulated quantum annealing process to adjust the determined cost function value. Further, the processor 104 may be configured to route the insurance claim to the selected optimal model combination for processing the insurance claim.

In an embodiment, the computer-implemented system 102 may be configured to perform the self-healing of the multiple parallel processing ensembles of the first generative AI model, the second generative AI model, and the third generative AI model using the Bayesian uncertainty quantification model. Further, the processor 104 may be configured to: execute a plurality of parallel instances of extracting decision rules using the first generative AI model, forming the decision tree, traversing the decision tree using the second generative AI model, and reviewing the result using the third generative AI model. Each parallel instance corresponds to an independent variant of the first generative AI model, the second generative AI model, and the third generative AI model. Further, the processor 104 may be configured to: compute one or more confidence scores corresponding to outputs of each of the plurality of parallel instances using a Monte Carlo dropout sampling model. Further, the term “Monte Carlo dropout sampling model” may refer to a probabilistic inference technique that applies dropout during multiple forward passes of a neural network to approximate Bayesian uncertainty. Further, the processor 104 may be configured to detect one or more deviations in the computed one or more confidence scores based on a predefined threshold value. Further, the term “predefined threshold value” may refer to a fixed numerical or categorical limit established in advance to guide evaluation, comparison, or decision outcomes. Further, the processor 104 may be configured to automatically retrain at least one specific parallel instance deviating from the predefined threshold value based on the detected one or more deviations using synthetic insurance claims generated by the first generative AI model. Further, the processor 104 may be configured to select the final result as a weighted combination of the outputs of each of the plurality of parallel instances.

In an embodiment, the processor 104 may be configured to detect at least one deviation in the pre-determined domain-specific knowledge graph by comparing one or more distributions of the relationships encoded in the pre-determined domain-specific knowledge graph before and after processing updated insurance policy documents using the first generative AI model. Further, the processor 104 may be configured to generate synthetic test claims using the first generative AI model in response to detecting the at least one deviation in the pre-determined domain-specific knowledge graph.

In an embodiment, the input data reception and decision rule extraction module 202 may receive health insurance claims in a standardized electronic format from at least one user device 118A-N and may also receive insurance claims from a third-party claims system via the API 110. Furthermore, the input data reception and decision rule extraction module 202 may collect at least one of claimant data, healthcare provider information, and member claim history from the data sources 114A-N. Further, a policy document database among the data sources 114A-N may store healthcare insurance policy documents in a structured and easily accessible format including at least one of rules, guidelines, and criteria for various medical procedures, treatments, and insurance policies. Further, the input data reception and decision rule extraction module 202 may function as an intelligent retrieval agent based on a combination of at least one of a Large Language Model, vector embeddings, and prompt engineering to retrieve specific information from the input data required as part of the adjudication decisioning workflow. Furthermore, the data conversion module within the input data reception and decision rule extraction module 202 may include the pre-trained generative Large Language Model fine-tuned for interpreting healthcare-related documents and claims to convert unstructured information present in the healthcare policy documents into the plurality of decision rules.

Further, the decision tree construction module 204 may include the pre-trained generative Large Language Model corresponding to the second Gen AI model with reasoning capabilities to process the insurance claim according to the plurality of decision rules extracted by the data conversion module. Furthermore, the decision tree construction module 204 may utilize the input data reception and decision rule extraction module 202 to gather all required information needed to process the insurance claim and may generate adjudication outcomes including at least one of an approval, a denial, and a flagging for manual review. The stepwise reasoning module 206 may employ a pre-trained generative Large Language Model corresponding to the third Gen AI model to apply chain-of-thought prompting techniques to review adjudication decisions generated by the decision tree construction module 204 in a stepwise manner and may log the stepwise reasoning path behind each adjudication decision in a structured format for evaluation purposes.

Further, the structured feedback and final adjudication module 210 may output the final adjudication result on a user interface dashboard displayed on at least one of the user devices 118A-N via the network 112. Furthermore, the user interface dashboard may provide detailed reasoning and policy document references for each adjudicated insurance claim and may enable manual intervention by authorized users when necessary.

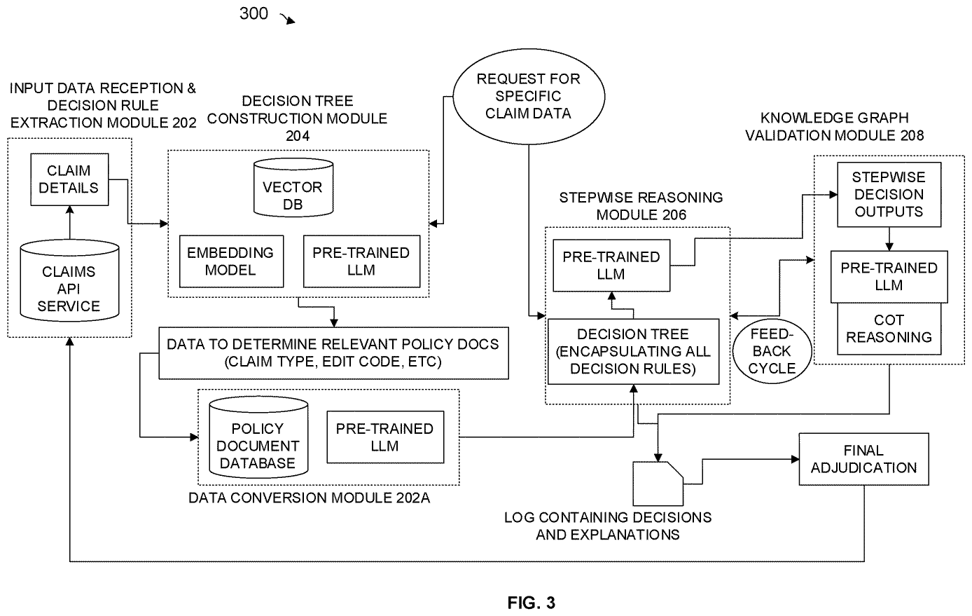

FIG. 3 illustrates an example flow diagram representation depicting an operational flow of the computer-implemented system 102 for processing insurance claim adjudication using the agentic Artificial Intelligence (AI) models, according to an example embodiment of the present disclosure.

Further, the input data reception and decision rule extraction module 202 may receive the electronic insurance claim submitted to the computer implemented system 102 via the claims API service from at least one of the user devices 118A-N and third-party claims systems via the network 112. Furthermore, the input data reception and decision rule extraction module 202 may receive supporting information along with the electronic insurance claim including at least one of a member claim history, claimant data, and healthcare provider information from the data sources 114A-N.

Further, the input data reception and decision rule extraction module 202 may extract relevant information from the received insurance claim including at least one of a claim type, member details, diagnosis codes, procedure codes, treatment codes, and healthcare provider information. Furthermore, the extracted relevant information may be transmitted to the decision tree construction module 204 for further processing as part of the adjudication decisioning workflow.

Further, the data conversion module 202a within the decision tree construction module 204 may retrieve relevant healthcare insurance policy documents from the policy document database among the data sources 114A-N based on the extracted claim details including at least one of a claim type, edit codes, and other claim-specific attributes. Furthermore, the data conversion module 202a may employ the pre-trained Large Language Model (LLM) and an embedding model in combination with a vector database to extract the plurality of decision rules from the retrieved healthcare insurance policy documents and convert the extracted plurality of decision rules into an actionable decision tree encapsulating all decision rules for use in adjudication processing.

Further, the decision tree construction module 204 may employ a pre-trained LLM corresponding to the second Gen AI model to act on the generated decision tree by applying deduction and reasoning to apply the plurality of decision rules extracted from the healthcare insurance policy documents. Furthermore, the decision tree construction module 204 may rely on the input data reception and decision rule extraction module 202 to fetch any necessary information needed to make adjudication decisions during traversal of the decision tree.

Further, the stepwise reasoning module 206 may employ the pre-trained LLM corresponding to the third Gen AI model with chain-of-thought reasoning capabilities to review possible mistakes and errors in adjudication decisions generated by the decision tree construction module 204 and may provide structured feedback accordingly. Furthermore, the structured feedback generated by the stepwise reasoning module 206 may be transmitted to the decision tree construction module 204 via a feedback cycle to rework adjudication decisions at the subset of nodes requiring re-evaluation. The stepwise reasoning module 206 may additionally generate an explanation for all adjudication decisions made as part of the decisioning workflow, adding a layer of explainability to the computer implemented system 102.

Further, the knowledge graph validation module 208 may receive stepwise decision outputs from the stepwise reasoning module 206 and may validate the received stepwise decision outputs against the pre-determined domain-specific knowledge graph. Furthermore, upon completion of the feedback cycle, the structured feedback and final adjudication module 210 may generate a final adjudication result corresponding to a verdict of at least one of an acceptance and a denial of the input insurance claim, along with an explanation of the final adjudication result referencing the plurality of insurance policy documents and the plurality of nodes of the decision tree. The knowledge graph validation module 208 may generate a log containing decisions and explanations corresponding to the validated stepwise decision outputs for audit and evaluation purposes.

Further, the structured feedback and final adjudication module 210 may deliver the final adjudication result to at least one of a healthcare provider and a payer associated with the insurance claim via the network 112. Furthermore, the user interface dashboard displayed on at least one of the user devices 118A-N may allow authorized users to perform a manual review of insurance claims flagged for further review, ensuring that automated adjudication decisions may be overseen and adjusted when necessary.

In an exemplary embodiment, a health insurance claim for authorization of a knee replacement surgery may be submitted to the computer implemented system 102 via the input data reception and decision rule extraction module 202. Furthermore, the input data reception and decision rule extraction module 202 may retrieve the insurance claim details from a healthcare provider system via the claims API service and may convert the retrieved insurance claim details into vector embeddings using the embedding model to enable retrieval of required claim information from the data sources 114A-N.

Further, the data conversion module 202a within the input data reception and decision rule extraction module 202 may identify all authorization scenario related healthcare insurance policy documents from the policy document database among the data sources 114A-N based on the extracted claim details. Furthermore, the data conversion module 202a may distill the identified healthcare insurance policy documents into a structured decision tree encapsulating all decision rules corresponding to the authorization scenario for knee replacement surgery.

In an embodiment, the input data reception and decision rule extraction module 202 may generate a retrieval prompt for the received insurance claim including at least one of a claim type, procedure codes, diagnosis codes, patient age, and prior treatment history to retrieve matching policy sections from the policy document database among the data sources 114A-N. Furthermore, the retrieval prompt may generate a structured output in a JSON format including at least one of a claim type, procedure codes, diagnosis codes, and policy matches with corresponding similarity scores.

Further, the data conversion module 202a may generate a rule extraction prompt for each identified policy section to extract decision rules as condition-action pairs from the identified policy section. Furthermore, the rule extraction prompt may generate a structured output in a JSON array format including at least one of a condition, an action, and a rule identifier corresponding to each extracted decision rule.

Further, the structured output generated by the data conversion module 202a may always correspond to a JSON format including at least one of a rule identifier, a condition in natural language, an action in natural language, a source policy section, and a confidence score corresponding to each extracted decision rule.

In an embodiment, the pre-trained Large Language Models employed by the input data reception and decision rule extraction module 202 and the data conversion module 202a may correspond to the models listed in Table 3 below.

TABLE 3

| Subsystem | Model | Size | Provider | Version |
|---|---|---|---|---|
| 208 | GPT-4o-mini | 8B params | OpenAI | 2024 Oct. 1 |
| (Retrieval) | | | API | |
| 208a (Rule | Llama 3.1 70B | 70B params | Self-hosted | Meta |
| Extraction) | | | (vLLM) | 2024 July |
| Backup | BERT-large-uncased | 340M params | Hugging | v2.0 |
| (both) | | | Face | |

Further, the decision tree construction module 204 may process each node in the structured decision tree by evaluating variables including at least one of prior claim filing criteria, severity of diagnosis, and pre-existing conditions of the claimant. Furthermore, the decision tree construction module 204 may interact with the input data reception and decision rule extraction module 202 during traversal of the decision tree to obtain at least one of patient claim history, recent doctor notes, and lab measurements required to evaluate the coverage conditions at each node of the decision tree.

Further, the stepwise reasoning module 206 may review all adjudication decisions generated by the decision tree construction module 204 during traversal of the decision tree and may generate structured feedback using chain-of-thought reasoning to analyze the adjudication decision outcomes with respect to the available claim information. Furthermore, the structured feedback generated by the stepwise reasoning module 206 may be transmitted to the decision tree construction module 204 via a feedback cycle to rework adjudication decisions at the subset of nodes requiring re-evaluation.

Further, upon completion of the feedback cycle, the structured feedback and final adjudication module 210 may log the final adjudication decisions and corresponding explanations for all nodes traversed during evaluation of the decision tree. Furthermore, the structured feedback and final adjudication module 210 may transmit the final adjudication result along with a corresponding explanation to the healthcare provider via the network 112, indicating a verdict of at least one of an authorization and a denial of the knee replacement surgery insurance claim.

In an embodiment, the decision tree construction module 204 may employ a recursive Large Language Model (LLM) tree induction algorithm to convert the extracted plurality of decision rules into a graph-based decision structure. Furthermore, the recursive LLM tree induction algorithm may parse the extracted decision rules into a condition-action graph, prompt the first Generative Artificial Intelligence (AI) model to construct a hierarchical decision tree in a JSON format, and validate the output via simulation.

Further, the JSON format output of the decision tree may include at least one of a root node, a node identifier, a condition in natural language, a rule identifier, true and false branch references, and a policy reference corresponding to each node of the decision tree. Furthermore, each node of the decision tree may reference a corresponding policy section from the plurality of insurance policy documents stored in the policy document database among the data sources 114A-N.

Further, in an embodiment, the decision tree generated for a knee replacement surgery authorization insurance claim may include seven nodes corresponding to at least one of an age or prior physical therapy condition at a root node, a Body Mass Index (BMI) condition, an infection condition, an imaging condition, a comorbidities condition, a provider criteria condition, and a final adjudication outcome of at least one of an approval and a denial at a leaf node.

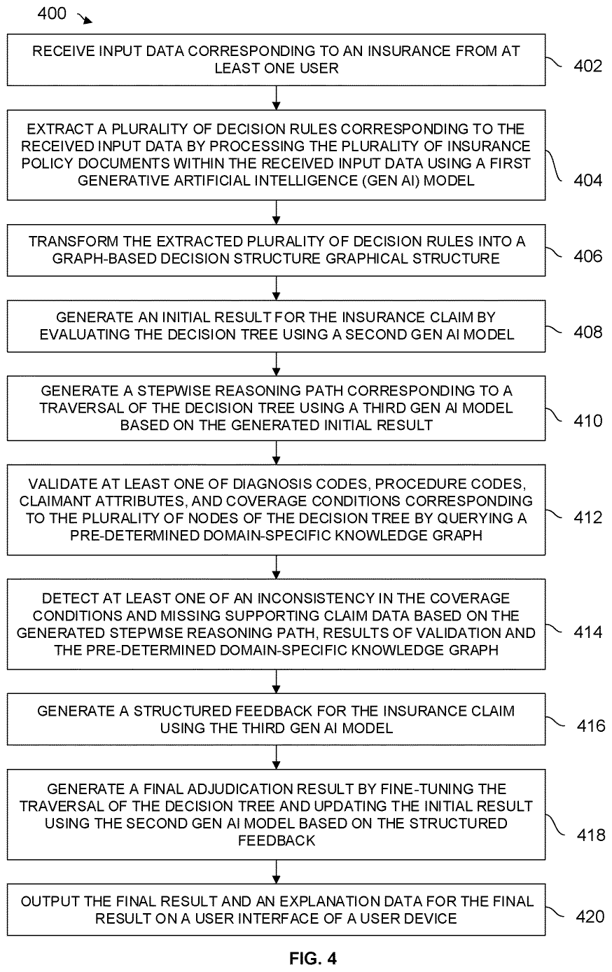

FIG. 4 illustrates an example flowchart depicting an example method 400 for processing insurance claims using agentic Artificial Intelligence (AI) models, according to an example embodiment of the present disclosure.

At step 402, the computer implemented method 400 may include receiving, by the processor 104, input data corresponding to the insurance from at least one user. The input data may include the insurance claim, the claimant history data, and the plurality of insurance policy documents.

At step 404, the computer implemented method 400 may include extracting, by the processor 104, the plurality of decision rules corresponding to the received input data by processing the plurality of insurance policy documents within the received input data using the first Generative Artificial Intelligence (Gen AI) model. The plurality of decision rules corresponds to a natural language data format.

At step 406, the computer implemented method 400 may include transforming, by the processor 104, the extracted plurality of decision rules into the graph-based decision structure. The graph-based decision structure may include the decision tree with a plurality of nodes and a plurality of edges. Each node represents a respective coverage condition obtained from the plurality of insurance policy documents.

At step 408, the computer implemented method 400 may include generating, by the processor 104, the initial result for the insurance claim by evaluating the decision tree using the second Gen AI model.

At step 410, the computer implemented method 400 may include generating, by the processor 104, the stepwise reasoning path corresponding to the traversal of the decision tree using the third Gen AI model based on the generated initial result. The third Gen AI model corresponds to a chain-of-thought reasoning model.

At step 412, the computer implemented method 400 may include validating, by the processor 104, at least one of diagnosis codes, procedure codes, claimant attributes, and coverage conditions corresponding to the plurality of nodes of the decision tree by querying a pre-determined domain-specific knowledge graph. The pre-determined domain-specific knowledge graph may include relationships among the plurality of decision rules.

At step 414, the computer implemented method 400 may include detecting, by the processor 104, at least one of the inconsistencies in the coverage conditions and missing supporting claim data based on the generated stepwise reasoning path, results of validation and the pre-determined domain-specific knowledge graph.

At step 416, the computer implemented method 400 may include generating, by the processor 104, the structured feedback for the insurance claim using the third Gen AI model. The structured feedback may indicate the subset of nodes requiring re-evaluation and subsequent relevant claim data to be retrieved.

At step 418, the computer implemented method 400 may include generating, by the processor 104, the final adjudication result by fine-tuning the traversal of the decision tree and updating the initial result using the second Gen AI model based on the structured feedback.

At step 420, the computer implemented method 400 may include outputting, by the processor 104, the final result and an explanation data for the final result on the user interface of the user device.

In an embodiment, the computer implemented method 400 may include extracting, by the processor 104, the plurality of decision rules corresponding to the received input data. Further, the computer implemented method 400 may include identifying, by the processor 104, one or more prompts for the input data using the first generative AI model. The one or more prompts may include the identified one or more relevant sections and the input data. Further, the computer implemented method 400 may include identifying, by the processor 104, the coverage conditions as natural language condition-action pairs by processing the generated one or more prompts using the first generative AI model. The coverage conditions may include the eligibility criteria, prior authorization requirements, coverage exclusions, treatment limitations, and reimbursement conditions. Further, the computer implemented method 400 may include generating, by the processor 104, the natural language responses to the one or more prompts by applying the one or more prompts to the first Gen AI model. Further, the computer implemented method 400 may include identifying, by the processor 104, condition phrases and corresponding action phrases by parsing the generated natural language responses using regular expressions model and rule-based post-processing model. Further, the computer implemented method 400 may include validating, by the processor 104, the condition phrases and the corresponding action phrases based on a predefined ontology model. Further, the computer implemented method 400 may include embedding, by the processor 104, the condition phrases and the corresponding action phrases into the plurality of decision rules. The plurality of decision rules may include rule identifiers, source policy sections, natural language conditions, and natural language actions.

In an embodiment, the computer implemented method 400 may include transforming, by the processor 104, the extracted plurality of decision rules into the graph-based decision structure. Further, the computer implemented method 400 may include preprocessing, by the processor 104, the natural language conditions and natural language actions within the extracted plurality of decision rules into the standardized intermediate representation by applying at least one of the tokenization process, the syntactic parsing process, and the semantic role labelling process on the extracted plurality of decision rules. Further, the computer implemented method 400 may include identifying, by the processor 104, the one or more decision variables, conditional operators, and outcome actions associated with each of the plurality of decision rules based on the standardized intermediate representation. Further, the computer implemented method 400 may include mapping, by the processor 104, the identified one or more decision variables to corresponding claim attributes using a predefined ontology model. The claim attributes may include at least one of the diagnosis codes, the procedure codes, the claimant attributes, and policy parameters. Further, the computer implemented method 400 may include classifying, by the processor 104, each of the plurality of decision rules into one of a plurality of rule types based on the mapping. The plurality of rule types may include eligibility rules, exclusion rules, dependency rules, and sequencing rules. Further, the computer implemented method 400 may include determining, by the processor 104, logical dependencies among the plurality of decision rules by analyzing at least one of shared decision variables, conditional relationships, and hierarchical policy structures. Further, the computer implemented method 400 may include generating, by the processor 104, the directed graph structure by assigning each of the plurality of decision rules to the corresponding node and directed edges between nodes based on the determined logical dependencies and an evaluation order. Further, the computer implemented method 400 may include converting, by the processor 104, the directed graph structure into the decision tree by assigning the root node corresponding to an initial eligibility condition, generating intermediate nodes corresponding to conditional evaluations, and defining leaf nodes corresponding to results. The results may include one of the approval, the denial, and flagging for review. Further, the computer implemented method 400 may include encoding, by the processor 104, the corresponding evaluation function for each node based on the decision tree. The corresponding evaluation function may include the coverage condition, the claim attributes, and decision thresholds obtained from the plurality of insurance policy documents. Further, the computer implemented method 400 may include determining, by the processor 104, overlapping decision rules by applying at least one of the priority ranking, the rule weighting, and conflict resolution heuristics to the decision tree based on the policy hierarchy and the rule specificity. Further, the computer implemented method 400 may include validating, by the processor 104, the structural consistency of the decision tree by determining completeness of the corresponding evaluation function, absence of cyclic dependencies, and coverage of relevant policy conditions. Further, the computer implemented method 400 may include generating, by the processor 104, the decision tree in the machine-readable format based on the validated structural consistency of the decision tree.

In an embodiment, the computer implemented method 400 may include generating, by the processor 104, the initial result for the insurance claim by evaluating the decision tree using the second Gen AI model. Further, the computer implemented method 400 may include initializing, by the processor 104, the traversal process at the root node of the decision tree corresponding to the initial coverage condition. Further, the computer implemented method 400 may include generating, by the processor 104, the contextual representation of the relevant claim data using the second generative AI model by encoding at least one of the insurance claim, claimant history data, and policy-related attributes. Further, the computer implemented method 400 may include traversing, by the processor 104, the decision tree by iteratively evaluating the plurality of nodes using the second generative AI model until the terminal node corresponding to a result is reached. Further, the computer implemented method 400 may include generating, by the processor 104, the reasoning sequence associated with the insurance claim by aggregating node-level decision outputs generated across the traversal. Further, the computer implemented method 400 may include determining, by the processor 104, the initial result based on the result associated with the terminal node. Further, the computer implemented method 400 may include generating, by the processor 104, intermediate decision metadata comprising at least one of traversal paths, evaluated coverage conditions, retrieved claim data, and the node-level decision outputs.

In an embodiment, the computer implemented method 400 may include iteratively evaluate the plurality of nodes using the second generative AI model. Further, the computer implemented method 400 may include retrieving, by the processor 104, the corresponding evaluation function for each node detected during traversal of the decision tree. The corresponding evaluation function may include the coverage condition, the claim attributes, and the decision criteria. Further, the computer implemented method 400 may include generating, by the processor 104, the context-aware prompt using the second generative AI model. The context-aware prompt may include the coverage condition, the claim attributes, and the contextual representation of the relevant claim data. Further, the computer implemented method 400 may include generating, by the processor 104, the node-level decision output by evaluating the coverage condition with the relevant claim data using the generated context-aware prompt. the node-level decision output may indicate one of a satisfaction of the coverage condition and the non-satisfaction of the coverage condition.

In an embodiment, the computer implemented method 400 may include generating the stepwise reasoning path corresponding to the traversal of the decision tree using the third Gen AI model based on the generated initial result. Further, the computer implemented method 400 may include receiving, by the processor 104, at least one of the initial result, intermediate decision metadata, traversal paths, and the decision tree generated by the second generative AI model. Further, the computer implemented method 400 may include regenerating, by the processor 104, the sequence of nodes traversed during evaluation of the decision tree based on the received initial result, the intermediate decision metadata, the traversal paths, and the decision tree. The sequence of nodes may include the order of evaluation of the plurality of nodes. Further, the computer implemented method 400 may include extracting, by the processor 104, the coverage conditions, node-level decision outputs, and the claim attributes for each node in the regenerated sequence of nodes. Further, the computer implemented method 400 may include generating, by the processor 104, the structured prompt using the third generative AI model. The structured prompt may include the regenerated sequence of nodes, the coverage conditions, the claim attributes, and the node-level decision outputs. Further, the computer implemented method 400 may include iterating, by the processor 104, processing the structured prompt using the third generative AI model to generate the sequence of intermediate reasoning steps. Each intermediate reasoning step may include the explanation to the evaluation of the respective node. Further, the computer implemented method 400 may include generating, by the processor 104, the node-aligned reasoning sequence by mapping each intermediate reasoning step with the corresponding node in the decision tree. The intermediate reasoning step may include references to supporting evidence from the claim data and sections in the plurality of insurance policy documents. Further, the computer implemented method 400 may include validating, by the processor 104, the logical consistency within the sequence of the intermediate reasoning steps to determine an alignment between the node-level decision outputs and the coverage conditions. Further, the computer implemented method 400 may include generating, by the processor 104, the stepwise reasoning path as the ordered chain-of-thought representation based on the validated logical consistency. The stepwise reasoning path may include the sequence of intermediate reasoning steps corresponding to the traversal of the decision tree.

In an embodiment, the computer implemented method 400 may include validating the at least one of the diagnosis codes, the procedure codes, the claimant attributes, and the coverage conditions corresponding to the plurality of nodes of the decision tree. Further, the computer implemented method 400 may include extracting, by the processor 104, validation elements from the at least one of the stepwise reasoning paths, the intermediate decision metadata, and the traversal paths. The validation elements may include the diagnosis codes, the procedure codes, the claimant attributes, the coverage conditions applied at each node, and the node-level decision outputs. Further, the computer implemented method 400 may include preprocessing, by the processor 104, the extracted validation elements into a standardized representation using at least one of an ontology mapping process, the code normalization process, and the semantic alignment process. Further, the computer implemented method 400 may include generating, by the processor 104, one or more structured queries for the pre-determined domain-specific knowledge graph by mapping the preprocessed validation elements to corresponding entities and relationships encoded within the pre-determined domain-specific knowledge graph. Each query corresponds to the validation check associated with at least one node of the decision tree. Further, the computer implemented method 400 may include executing, by the processor 104, the one or more structured queries on the pre-determined domain-specific knowledge graph to retrieve relationship data representing one or more dependencies among the plurality of insurance policy rules, the diagnosis codes, the procedure codes, and the claimant attributes. Further, the computer implemented method 400 may include determining, by the processor 104, whether the coverage conditions may be consistent with the relationships encoded in the pre-determined domain-specific knowledge graph by comparing the retrieved relationship data with the coverage conditions applied at the plurality of nodes. Further, the computer implemented method 400 may include evaluating, by the processor 104, whether the diagnosis codes and the procedure codes satisfy policy-defined eligibility constraints, the claimant attributes comply with policy-specific conditions, and the coverage conditions reflect the dependencies among the extracted validation elements. Further, the computer implemented method 400 may include generating, by the processor 104, one or more validation results including at least one of consistency of the coverage conditions, inconsistency between the coverage conditions and knowledge graph relationships, and absence of required relationships in the pre-determined domain-specific knowledge graph. Further, the computer implemented method 400 may include generating, by the processor 104, validation metadata indicating the validation status and corresponding conflicting relationships retrieved from the pre-determined domain-specific knowledge graph.

In an embodiment, the computer implemented method 400 may include detecting the at least one of the inconsistency in the coverage conditions and the missing supporting claim data based on the generated stepwise reasoning path, the results of validation and the pre-determined domain-specific knowledge graph. Further, the computer implemented method 400 may include receiving, by the processor 104, at least one of the stepwise reasoning paths, the validation metadata, the intermediate decision metadata, and the traversal paths associated with evaluation of the decision tree. Further, the computer implemented method 400 may include extracting, by the processor 104, one or more comparison elements from the received information. The one or more comparison elements may include the node-level decision outputs, the coverage conditions applied at each node, the claim attributes, the diagnosis codes, the procedure codes, and the results of validation obtained from the pre-determined domain-specific knowledge graph. Further, the computer implemented method 400 may include aligning, by the processor 104, the comparison elements for each node by correlating the node-level decision outputs with the coverage conditions and the results of validation. Further, the computer implemented method 400 may include determining, by the processor 104, the expected outcome based on the relationships retrieved from the pre-determined domain-specific knowledge graph and the claim attributes. Further, the computer implemented method 400 may include comparing, by the processor 104, the node-level decision outputs with the expected outcomes to identify discrepancies between the coverage conditions and the relationships defined in the pre-determined domain-specific knowledge graph. Further, the computer implemented method 400 may include identifying, by the processor 104, an inconsistency in the coverage conditions if the node-level decision output deviates from the expected outcome obtained from the pre-determined domain-specific knowledge graph, the coverage condition contradicts the relationships encoded in the pre-determined domain-specific knowledge graph, and the sequence of reasoning steps in the stepwise reasoning path indicates logical conflicts for the plurality of nodes. Further, the computer implemented method 400 may include detecting, by the processor 104, one or more issues in the generated stepwise reasoning path and the results of validation. The one or more issues may include at least one of the absences of required claim attributes, the diagnosis codes, and the procedure codes associated with the coverage condition, the presence of unsupported stepwise reasoning path references, and the absence of required dependencies. Further, the computer implemented method 400 may include classifying, by the processor 104, each detected issue as at least one of the logical inconsistencies, the policy inconsistency, the data insufficiency, and the incomplete evaluation condition. Further, the computer implemented method 400 may include generating, by the processor 104, inconsistency metadata for each detected issue. The inconsistency metadata may include at least one of the identifiers of the corresponding node, the type of inconsistency, missing information, the description of the discrepancy, and the reference to the coverage condition and the results of validation.

In an embodiment, the computer implemented method 400 may include generating the structured feedback for the insurance claim using the third Gen AI model. Further, the computer implemented method 400 may include identifying, by the processor 104, the subset of nodes of the decision tree associated with detected inconsistencies and missing supporting claim data based on the stepwise reasoning path, the inconsistency metadata, the validation metadata, the intermediate decision metadata, and the traversal paths associated with evaluation of the decision tree. Further, the computer implemented method 400 may include classifying, by the processor 104, an issue type for each node in the subset of nodes. The issue type may include at least one of the logical inconsistencies, the policy inconsistency, the data insufficiency, and the incomplete evaluation condition. Further, the computer implemented method 400 may include extracting, by the processor 104, the coverage conditions, node-level decision outputs, the claim attributes, and the results of validation for each node in the subset of nodes. Further, the computer implemented method 400 may include generating, by the processor 104, the structured prompt using the third generative AI model. The structured prompt may include the identified subset of nodes, the issue type, the coverage conditions, the node-level decision outputs, and the results of validation. Further, the computer implemented method 400 may include generating, by the processor 104, corrective reasoning instructions for each node in the subset of nodes by processing the structured prompt using the third generative AI model. Further, the computer implemented method 400 may include determining, by the processor 104, one or more re-evaluation actions based on the corrective reasoning instructions. The one or more re-evaluation actions may include re-evaluating the coverage condition, modifying a decision threshold, revisiting the traversal path, and requesting supporting data. Further, the computer implemented method 400 may include identifying, by the processor 104, relevant claim data required to resolve the detected issue for each node requiring re-evaluation. The relevant claim data may include at least one of missing diagnosis codes, missing procedure codes, incomplete claimant attributes, and absent supporting documentation. Further, the computer implemented method 400 may include generating, by the processor 104, the structured feedback for each node in the subset of nodes. The structured feedback may include the node identifier, the issue type, the re-evaluation instruction, the specification of the relevant claim data to be retrieved, and the priority level associated with the re-evaluation.

In an embodiment, the computer implemented method 400 may include generating the final result by refining the traversal of the decision tree and updating the initial result using the second generative artificial intelligence (AI) model based on the structured feedback. Further, the computer implemented method 400 may include identifying, by the processor 104, the subset of nodes requiring re-evaluation and corresponding re-evaluation instructions based on the structured feedback. Further, the computer implemented method 400 may include retrieving, by the processor 104, subsequent relevant claim data specified in the structured feedback from at least one of a data retrieval subsystem, external data sources, and the input data. Further, the computer implemented method 400 may include updating, by the processor 104, the contextual representation of the relevant claim data based on the retrieved subsequent claim data. Further, the computer implemented method 400 may include selectively re-traversing, by the processor 104, the decision tree by re-evaluating the subset of nodes identified in the structured feedback. Further, the computer implemented method 400 may include reconstructing, by the processor 104, the node-specific evaluation context for each node in the subset of nodes. The node-specific evaluation context may include the updated claim data and the coverage condition. Further, the computer implemented method 400 may include generating, by the processor 104, the revised context-aware prompt using the second generative AI model. Further, the computer implemented method 400 may include generating, by the processor 104, the updated node-level decision output by re-evaluating the coverage condition. Further, the computer implemented method 400 may include generating, by the processor 104, the updated result as the final adjudication result by recomputing the traversal path based on the updated node-level decision output.

In an embodiment, the computer implemented method 400 may include performing, by the processor 104, federated fine-tuning of the first generative AI model, the second generative AI model, and the third generative AI model corresponding to a plurality of insurance systems using a secure multi-party computation model. Further, the computer implemented method 400 may include performing, by the processor 104, quantum-inspired routing of the insurance claim to the optimal combination of the first generative AI model, the second generative AI model, and the third generative AI model. Further, the computer implemented method 400 may include performing, by the processor 104, self-healing of multiple parallel processing ensembles of the first generative AI model, the second generative AI model, and the third generative AI model using a Bayesian uncertainty quantification model. Further, the computer implemented method 400 may include generating, by the processor 104, the final result referencing the plurality of insurance policy documents and the plurality of nodes of the decision tree based on the performed federated fine-tuning, the quantum-inspired routing, and the self-healing process.

In an embodiment, the computer implemented method 400 may include performing the fine-tuning of the first generative AI model, the second generative AI model, and the third generative AI model. Further, the computer implemented method 400 may include fine-tuning, by the processor 104, the first generative AI model, the second generative AI model, and the third generative AI model locally at each of the insurance systems using specific training data including insurance claims and the plurality of policy documents. Further, the computer implemented method 400 may include computing, by the processor 104, one or more gradient update values based on the fine-tuned first generative AI model, the fine-tuned second generative AI model, and the fine-tuned third generative AI model. Further, the computer implemented method 400 may include generating, by the processor 104, the global model update value by federated aggregating the computed one or more gradient update values for each of the plurality of insurance systems using the secure multi-party computation model.

In an embodiment, the computer implemented method 400 may include performing the quantum-inspired routing of the insurance claim to the optimal combination of the first generative AI model, the second generative AI model, and the third generative AI model. Further, the computer implemented method 400 may include determining, by the processor 104, the cost function value may include at least one of a decision tree depth, claim risk factors, and historical model performance for a plurality of combinations of the first generative AI model, the second generative AI model, and the third generative AI model. The claim risk factors may include the billed amount, the procedure complexity, and claimant health attributes. Further, the computer implemented method 400 may include selecting, by the processor 104, the optimal model combination by applying the simulated quantum annealing process to adjust the determined cost function value. Further, the computer implemented method 400 may include routing, by the processor 104, the insurance claim to the selected optimal model combination for processing the insurance claim.

In an embodiment, the computer implemented method 400 may include performing the self-healing of the multiple parallel processing ensembles of the first generative AI model, the second generative AI model, and the third generative AI model using the Bayesian uncertainty quantification model. Further, the computer implemented method 400 may include executing, by the processor 104, the plurality of parallel instances of extracting decision rules using the first generative AI model, forming the decision tree, traversing the decision tree using the second generative AI model, and reviewing the result using the third generative AI model. Each parallel instance corresponds to the independent variant of the first generative AI model, the second generative AI model, and the third generative AI model. Further, the computer implemented method 400 may include computing, by the processor 104, one or more confidence scores corresponding to outputs of each of the plurality of parallel instances using the Monte Carlo dropout sampling model. Further, the computer implemented method 400 may include detecting, by the processor 104, one or more deviations in the computed one or more confidence scores based on the predefined threshold value. Further, the computer implemented method 400 may include automatically retraining, by the processor 104, at least one specific parallel instance deviating from the predefined threshold value based on the detected one or more deviations using synthetic insurance claims generated by the first generative AI model. Further, the computer implemented method 400 may include selecting, by the processor 104, the final result as the weighted combination of the outputs of each of the plurality of parallel instances.

In an embodiment, the computer implemented method 400 may include detecting, by the processor, at least one deviation in the pre-determined domain-specific knowledge graph by comparing one or more distributions of the relationships encoded in the pre-determined domain-specific knowledge graph before and after processing updated insurance policy documents using the first generative AI model. Further, the computer implemented method 400 may include generating, by the processor, synthetic test claims using the first generative AI model in response to detecting the at least one deviation in the pre-determined domain-specific knowledge graph.

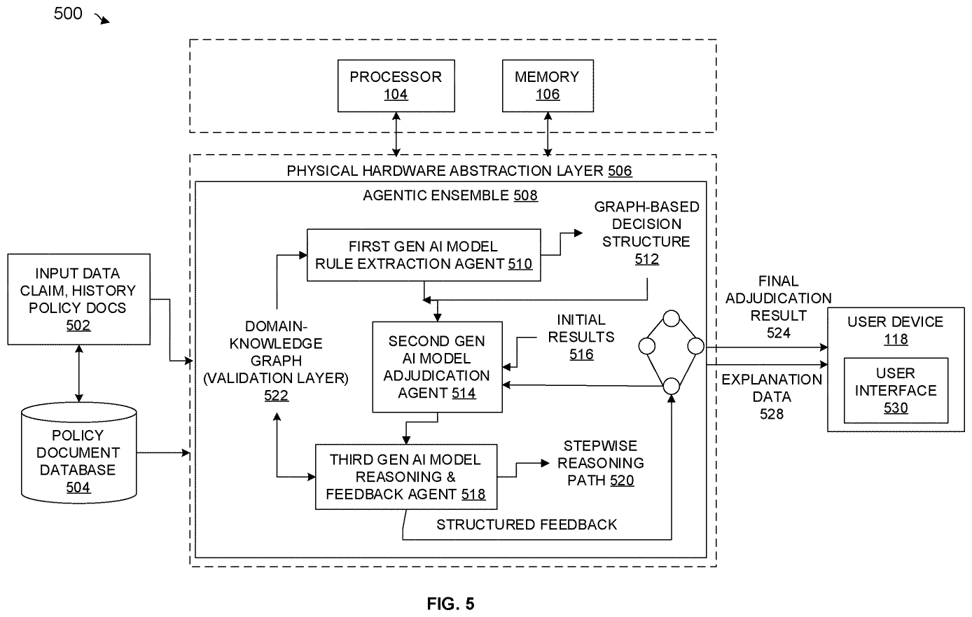

FIG. 5 illustrates an example block diagram of an agentic ensemble 508 for processing insurance claim adjudication using the agentic Artificial Intelligence (AI) models within the computer implemented system 102, according to an example embodiment of the present disclosure.

Further, the agentic ensemble 508 may operate within a physical hardware abstraction layer 506 communicably coupled to the processor 104 and the memory 106 of the computer implemented system 102. Furthermore, the agentic ensemble 508 may receive input data 502 including at least one of an insurance claim, claimant history, and insurance policy documents along with the policy document database 504 as primary inputs for processing insurance claim adjudication.

Further, the agentic ensemble 508 may include the first Generative Artificial Intelligence (Gen AI) model 510 corresponding to a rule extraction agent, the second Gen AI model 514 corresponding to the adjudication agent, and a third Gen AI model 518 corresponding to a reasoning and feedback agent. Further, the term “rule extraction agent” may refer to a computational component or module that may be configured to identify, derive, and formalize decision rules from structured or unstructured sources such as policy documents, claim records, or adjudication outcomes. Further, the term “adjudication agent” may refer to a computational component or module configured to evaluate insurance claims against applicable policy rules, coverage conditions, and decision criteria in order to generate adjudication outcomes. Furthermore, the first Generative Artificial Intelligence (Gen AI) model 510, the second Generative Artificial Intelligence (Gen AI) model 514, and the third Generative Artificial Intelligence (Gen AI) model 518 may operate collectively within the agentic ensemble 508 to perform all adjudication processing operations described herein.

Further, the first Generative Artificial Intelligence (Gen AI) model 510 may receive the input data 502 and the policy document database 504 and may generate a graph-based decision structure 512 by extracting a plurality of decision rules from the insurance policy documents. Furthermore, the graph-based decision structure 512 generated by the first Generative Artificial Intelligence (Gen AI) model 510 that may be transmitted to the second Gen AI model 514 for adjudication processing.

Further, the second Generative Artificial Intelligence (Gen AI) model 514 may receive the graph-based decision structure 512 from the first Generative Artificial Intelligence (Gen AI) model 510 and may generate an initial result 516 by evaluating the graph-based decision structure 512 against the received input data 502. Furthermore, the initial result 516 generated by the second Generative Artificial Intelligence (Gen AI) model 514 may be transmitted to the third first Generative Artificial Intelligence (Gen AI) model 518 for reasoning and feedback processing.

Further, the third Generative Artificial Intelligence (Gen AI) model 518 may receive the initial result 516 from the second Generative Artificial Intelligence (Gen AI) model 514 and may generate a stepwise reasoning path 520 corresponding to a traversal of the graph-based decision structure 512. Furthermore, the third Generative Artificial Intelligence (Gen AI) model 518 may generate structured feedback based on the stepwise reasoning path 520 and may transmit the structured feedback to the second Gen AI model 514 to refine the initial result 516.

Further, a domain-knowledge graph 522 may serve as a validation layer within the agentic ensemble 508 and may be queried by at least one of the second Gen AI model 514 and the third Generative Artificial Intelligence (Gen AI) model 518 to validate coverage conditions, diagnosis codes, and procedure codes applied during evaluation of the graph-based decision structure 512. Further, the term “domain-knowledge graph” may refer to a structured representation of concepts, entities, and relationships specific to a given domain, organized in graph form to enable reasoning, inference, and contextual evaluation. Furthermore, the domain-knowledge graph 522 may encode relationships among the plurality of decision rules extracted from the insurance policy documents by the first Gen AI model 510.

Further, the agentic ensemble 508 may generate a final adjudication result 524 and corresponding explanation data 528 based on the refined traversal of the graph-based decision structure 512 by the second Generative Artificial Intelligence (Gen AI) model 514 upon completion of the structured feedback cycle. Furthermore, the final adjudication results 524 and the explanation data 528 may be transmitted to a user device 118 for display on a user interface 530, enabling authorized users to review the final adjudication result 524 and corresponding explanation data 528.

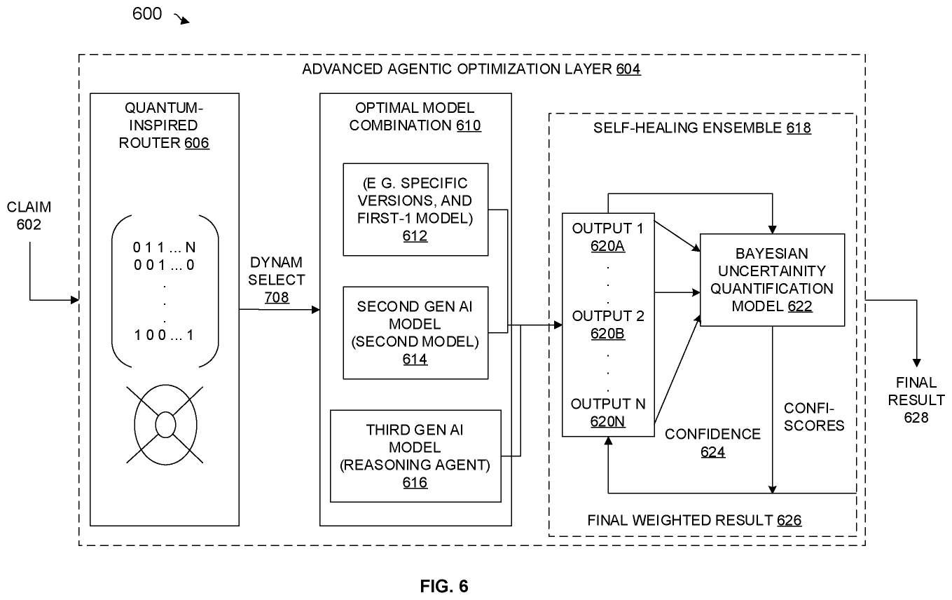

FIG. 6 illustrates a block diagram of an advanced agentic optimization layer 604 for processing insurance claim adjudication within the computer implemented system 102, according to an example embodiment of the present disclosure.

Further, the advanced agentic optimization layer 604 may receive an insurance claim 602 as input and may process the received insurance claim 602 through a quantum-inspired router 606, an optimal model combination 610, and a self-healing ensemble 618 to generate a final result 628. Further, the term “quantum-inspired router” may refer to a computational routing component that may be configured to distribute input data across multiple processing paths using matrix-style allocation or probabilistic selection techniques inspired by quantum computing principles. Further, the term “optimal model combination” may refer to a processing module that may be configured to integrate outputs from multiple models or model versions in a coordinated manner to improve accuracy, diversity, or robustness of reasoning. Further, the term “self-healing ensemble” may refer to a collection of models or agents that may be configured to generate multiple outputs and automatically adjust or recover from inconsistencies, errors, or degraded performance. Furthermore, the advanced agentic optimization layer 604 may operate within the computer implemented system 102 to optimize the selection and coordination of the first Generative Artificial Intelligence (Gen AI) model 612, the second Generative Artificial Intelligence (Gen AI) model 614, and the third Generative Artificial Intelligence (Gen AI) model 616 during insurance claim adjudication processing.

Further, the quantum-inspired router 606 may receive the insurance claim 602 and may apply a quantum-inspired routing matrix to dynamically select an optimal combination of the first Generative Artificial Intelligence (Gen AI) model 612, the second Gen AI model 614, and the third G Generative Artificial Intelligence (Gen AI) AI model 616 for processing the received insurance claim 602. Further, the term “quantum-inspired routing matrix” may refer to a structured allocation framework configured to represent routing paths in matrix form, where binary or probabilistic values determine the distribution of input data across multiple processing channels. Furthermore, the quantum-inspired router 606 may perform a dynamic selection 708 based on at least one of a decision tree depth, claim risk factors, and historical model performance associated with a plurality of combinations of the first Generative Artificial Intelligence (Gen AI) model 612, the second Generative Artificial Intelligence (Gen AI) model 614, and the third Generative Artificial Intelligence (Gen AI) model 616.

Further, the optimal model combination 610 may include the first Generative Artificial Intelligence (Gen AI) model 612 corresponding to specific versions and a first model configuration, the second Generative Artificial Intelligence (Gen AI) model 614 corresponding to a second model configuration, and the third Generative Artificial Intelligence (Gen AI) model 616 corresponding to a reasoning agent. Furthermore, the optimal model combination 610 selected by the quantum-inspired router 606 may process the received insurance claim 602 and may generate a plurality of outputs 620A-N corresponding to independent adjudication processing results for transmission to the self-healing ensemble 618.

Further, the self-healing ensemble 618 may receive the plurality of outputs 620A-N from the optimal model combination 610 and may utilize a Bayesian uncertainty quantification model 622 to compute one or more confidence scores 624 corresponding to each of the plurality of outputs 620A-N. Further, the term “Bayesian uncertainty quantification model” may refer to a computational model that may be configured to evaluate the reliability of outputs by applying Bayesian statistical methods to estimate uncertainty and confidence levels. Furthermore, the Bayesian uncertainty quantification model 622 may detect one or more deviations in the computed confidence scores 624 based on a predefined threshold value and may automatically retrain at least one specific output instance deviating from the predefined threshold value.

Further, the self-healing ensemble 618 may generate a final weighted result 626 by computing a weighted combination of the plurality of outputs 620A-N based on the corresponding confidence scores 624 generated by the Bayesian uncertainty quantification model 622. Furthermore, the final weighted result 626 may be transmitted as the final result 628 of the advanced agentic optimization layer 604 corresponding to the final adjudication result for the received insurance claim 602.

In an embodiment, the self-healing ensemble 618 may execute three parallel agent triplets corresponding to diverse LLM seeds of the first Generative Artificial Intelligence (AI) model 612, the second Generative Artificial Intelligence (AI) model 614, and the third Generative Artificial Intelligence (AI) model 616 to generate a plurality of outputs 620A-N for each received insurance claim 602.

Further, the Bayesian uncertainty quantification model 622 may compute one or more confidence scores 624 corresponding to each of the plurality of outputs 620A-N using Monte Carlo dropout sampling with a dropout probability of 0.1 across 50 forward passes per agent triplet. Furthermore, the Bayesian uncertainty quantification model 622 may compute an ensemble variance across the plurality of outputs 620A-N based on the computed confidence scores 624.

Further, the self-healing ensemble 618 may trigger a self-healing process when the computed ensemble variance may exceed a predefined threshold value of 0.15. Furthermore, upon triggering the self-healing process, the outlier agent triplet among the three parallel agent triplets may be retrained on-the-fly using synthetic insurance claims generated by the first Generative Artificial Intelligence (AI) model 612.

Further, the self-healing ensemble 618 may generate a final weighted result 626 corresponding to the final adjudication result by computing an uncertainty-weighted vote across the plurality of outputs 620A-N based on the confidence scores 624 generated by the Bayesian uncertainty quantification model 622.

In an embodiment, the quantum-inspired router 606 may dynamically route the insurance claim 602 to an optimal combination of the first Generative Artificial Intelligence (AI) model 612, the second Generative Artificial Intelligence (AI) model 614, and the third Generative Artificial Intelligence (AI) model 616 by minimizing a cost Hamiltonian encoding at least one of a decision tree complexity, a claim sensitivity, and a historical model accuracy. Furthermore, the quantum-inspired router 606 may employ a quantum annealing simulator including at least one of a D-Wave API and a simulated annealing process to determine the optimal agent combination for processing the received insurance claim 602.

Further, the cost Hamiltonian minimized by the quantum-inspired router 606 may encode at least one of a decision tree complexity, a claim sensitivity, and a historical model accuracy as cost factors for determining the optimal agent combination for processing the received insurance claim 602.

Furthermore, the claim risk factors may include at least one of a billed amount, a procedure complexity, and claimant health attributes. Furthermore, the optimal agent combination selected by the quantum-inspired router 606 may reduce wrong-branch errors in decision tree traversal by 22% by routing high-complexity and high-sensitivity insurance claims to the most accurate combination of Generative Artificial Intelligence (AI) models available within the agentic ensemble 508.

Further, in an embodiment, the simulated annealing process may iteratively adjust the cost Hamiltonian by evaluating a plurality of agent combination candidates and accepting or rejecting each candidate based on a probabilistic acceptance criterion until a minimum cost value may be reached. Furthermore, the optimal agent combination selected by the quantum-inspired router 606 may reduce wrong-branch errors in decision tree traversal by routing high-complexity and high-sensitivity insurance claims to the most accurate combination of Generative Artificial Intelligence (AI) models available within the agentic ensemble 508.

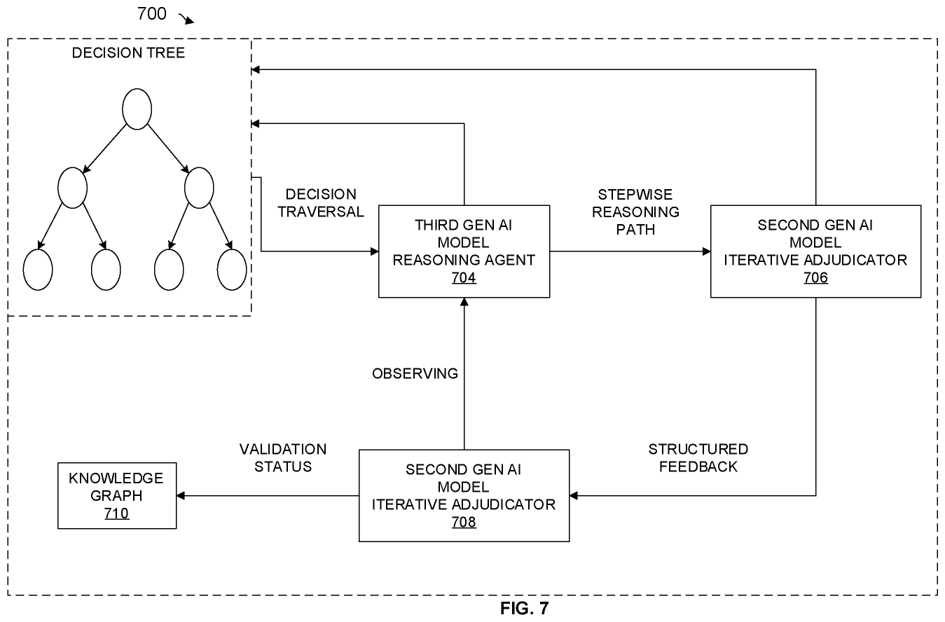

FIG. 7 illustrates an example block diagram representation of an iterative adjudication workflow 700 for processing insurance claim adjudication using the second and the third AI model within the computer implemented system 102, according to an example embodiment of the present disclosure.

Further, the decision tree 702 may transmit a decision traversal to the third Generative Artificial Intelligence (AI) model 704 corresponding to the reasoning agent for processing. Furthermore, the third Generative Artificial Intelligence (AI) model 704 may receive the decision traversal from the decision tree 702 and may generate the stepwise reasoning path corresponding to the traversal of the decision tree 702 for transmission to the second Generative Artificial Intelligence (AI) model 706 corresponding to the iterative adjudicator.

Further, the second Generative Artificial Intelligence (AI) model 706 may receive the stepwise reasoning path from the third Generative Artificial Intelligence (AI) model 704. The second Generative Artificial Intelligence (AI) model 706 may generate structured feedback based on the received stepwise reasoning path. Furthermore, the structured feedback generated by the second Generative Artificial Intelligence (AI) model 706 may be transmitted to the second Generative Artificial Intelligence (AI) model 708 corresponding to the iterative adjudicator for further processing and refinement of the adjudication decisions.

Further, the second Generative Artificial Intelligence (AI) model 708 may receive the structured feedback from the second Generative Artificial Intelligence (AI) model 706 and may transmit an observing signal to the third Generative Artificial Intelligence (AI) model 704 to enable the third Generative Artificial Intelligence (AI) model 704 to monitor and refine the iterative adjudication processing. Furthermore, the second Generative Artificial Intelligence (AI) model 708 may transmit a validation status to the knowledge graph 710 for validation of the coverage conditions, diagnosis codes, and procedure codes applied during traversal of the decision tree 702.

Further, the knowledge graph 710 may receive the validation status from the second Generative Artificial Intelligence (AI) model 708 and may validate the coverage conditions against the relationships encoded within the knowledge graph 710. Furthermore, the knowledge graph 710 may transmit validation results back to the decision tree 702 to update the traversal of the decision tree 702 based on the validated coverage conditions.

Further, the third Generative Artificial Intelligence (AI) model 704 and the second Generative Artificial Intelligence (AI) model 708 may each transmit updated outputs back to the decision tree 702 upon completion of the iterative adjudication and structured feedback cycle. Furthermore, the iterative adjudication workflow 700 may continue the feedback cycle among the decision tree 702, the third Generative Artificial Intelligence (AI) model 704, the second Generative Artificial Intelligence (AI) model 706, the second Generative Artificial Intelligence (AI) model 708, and the knowledge graph 710 until a final adjudication result may be generated by the computer implemented system 102.

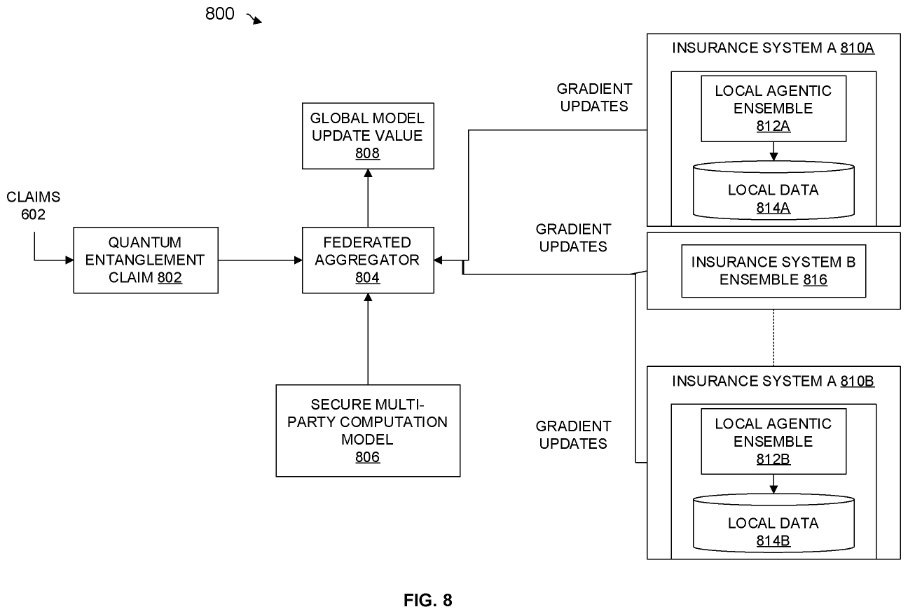

FIG. 8 illustrates an example block diagram representation of a federated fine-tuning workflow 800 for the Generative Artificial Intelligence (AI) models across a plurality of insurance systems within the computer implemented system 102, according to an example embodiment of the present disclosure.

Further, the federated fine-tuning workflow 800 may receive insurance claims 602 as input and may process the received insurance claims 602 through a quantum entanglement claim 802, a federated aggregator 804, a secure multi-party computation model 806, and a plurality of insurance systems 810A-810B to generate a global model update value 808. Further, the term “quantum entanglement claim” may refer to a claim construct configured to describe or encompass system behaviors, processes, or data relationships that may be modelled, abstracted, or inspired by principles of quantum entanglement. Furthermore, the federated fine-tuning workflow 800 may operate collectively to perform federated fine-tuning of the first Generative Artificial Intelligence (AI) model, the second Generative Artificial Intelligence (AI) model, and the third Generative Artificial Intelligence (AI) model across the plurality of insurance systems without sharing local data among the plurality of insurance systems.

Further, the below table discloses performance metrics evaluated using a benchmark including 5,000 held-out claims compared against assessments provided by three senior adjusters.

TABLE 4

| Metric | Value | Measurement |
|---|---|---|
| End-to-End Latency | 28 s avg (p95 = 45 s) | Claims processed December 2025 |
| Throughput | 1,800 claims/min | Peak load testing |
| Accuracy | 96.8% vs human experts | 5k claim A/B test (κ = 0.92) |
| Override Rate | 4.2% | Reduced 32% post-deployment |

In an embodiment, the computer implemented system 102 may be trained and validated using a combination of real-world and synthetic datasets. The training process may include labelled data annotated by a plurality of domain experts, where an inter-annotator agreement metric may be maintained to ensure consistency and reliability of annotations. Further, the system performance may be evaluated using one or more predefined evaluation metrics, including accuracy and precision, on a held-out dataset. The evaluation may be performed to validate the effectiveness of the decision-making and reasoning capabilities of the system. Below Table.5 may provide training and validation dataset sources and associated details used for developing and evaluating the computer implemented system 102.

TABLE 5

| Source | Size | Details |
|---|---|---|
| Autonomize Claims | 40k | De-ID claims + policies |
| Synthetic (GPT-4o) | 10k | Knee replacement, oncology auths |
| CMS Public | 2k | Medicare claims + synthetic rules |

In an embodiment, the computer implemented system 102 may implement a continuous improvement mechanism for enhancing performance of the generative AI models. The continuous improvement mechanism may include reinforcement learning from human feedback (RLHF), where human override decisions may be utilized to generate tree edit rewards, and a proximal policy optimization (PPO)-based fine-tuning may be performed on the second generative AI model at a weekly interval. Further, the continuous improvement mechanism may include online learning, where flagged claims may be incorporated into an active learning pool for subsequent model updates. Further, the system may perform drift detection based on a divergence metric associated with knowledge graph edges, where a Kullback-Leibler (KL) divergence value exceeding 0.05 may trigger policy re-extraction. Further, the continuous improvement mechanism may include A/B testing, where 10% of incoming traffic may be routed to one or more updated models for performance comparison. Further, the quantum entanglement claims 802 may receive the insurance claims 602 and may process the received insurance claims 602 for transmission to the federated aggregator 804. Furthermore, the federated aggregator 804 may receive processed insurance claims from the quantum entanglement claim 802 and may aggregate one or more gradient updates received from the plurality of insurance systems 810A-810B to generate the global model update value 808.

Further, the secure multi-party computation model 806 may operate in communication with the federated aggregator 804 to ensure secure aggregation of the one or more gradient updates received from the plurality of insurance systems 810A-810B. Furthermore, the secure multi-party computation model 806 may enable the federated aggregator 804 to compute the global model update value 808 without exposing local data 814A-814B of any individual insurance system among the plurality of insurance systems 810A-810B.

Further, the plurality of insurance systems 810A-810B may include insurance system 810A and insurance system B 816, each including a local agentic ensemble 812A-812B and local data 814A-814B. Furthermore, each of the plurality of insurance systems 810A-810B may fine-tune the first, second Generative Artificial Intelligence (AI) model, and the third Generative Artificial Intelligence (AI) model locally using specific training data including insurance claims and insurance policy documents stored within the local data 814A-814B.

Further, each of the local agentic ensembles 812A-812B may compute one or more gradient updates based on the locally fine-tuned first, second, and the third Generative Artificial Intelligence (AI) model and may transmit the computed one or more gradient updates to the federated aggregator 804. Furthermore, the federated aggregator 804 may generate the global model update value 808 by federally aggregating the computed one or more gradient updates received from each of the plurality of insurance systems 810A-810B using the secure multi-party computation model 806.

In an embodiment, the fine-tuning of the first Generative Artificial Intelligence (AI) model, the second Generative Artificial Intelligence (AI) model, and the third Generative Artificial Intelligence (AI) model may employ a dataset of 50,000 total samples including 80% proprietary de-identified claims and policy pairs anonymized via HIPAA-compliant tokenization, 15% synthetic claims generated via GPT-4o, and 5% public CMS claims augmented with synthetic policies from MIMIC-III clinical notes and rule templates.

Further, the fine-tuning may employ Low-Rank Adaptation (LoRA) on Llama 3.1 with a rank of 16 and alpha of 32. Furthermore, the hyperparameters employed during fine-tuning may correspond to the values listed in Table 6 below.

TABLE 6

| Parameter | Value |
|---|---|
| Learning Rate | le−5 |
| Epochs | 3 |
| Batch Size | 8 (gradient accumulation = 4) |
| Warmup Steps | 100 |
| Weight Decay | 0.01 |

In an embodiment, the fine-tuned first Generative Artificial Intelligence (AI) model may achieve a ROUGE-L score of 0.87 for rule extraction fidelity, an F1-Coverage score of 0.92 for condition identification, a BLEU score of 0.81 for action phrasing, and a human evaluation match rate of 94% against expert annotations.

In an embodiment, the computer implemented system 102 may perform federated learning across a plurality of payers by fine-tuning the first, second and the third Generative Artificial Intelligence (AI) model locally at each payer system using proprietary insurance claims and insurance policy documents stored within the local data 814A-814B. Furthermore, a local fine-tuning may enable each payer system to adapt the Generative Artificial Intelligence (AI) models to payer-specific coverage conditions and decision tree traversal patterns without exposing proprietary claim data to any other payer system.

Further, each of the local agentic ensembles 812A-812B may compute one or more gradient update values based on a tree-evaluation loss function adapted from a Federated Averaging (FedAvg) algorithm to account for decision tree traversal outputs and node-level decision outputs specific to insurance claim adjudication processing. Furthermore, each of the local agentic ensembles 812A-812B may transmit the computed gradient update values to the federated aggregator 804 via the secure multi-party computation model 806 without transmitting the underlying local data 814A-814B.

Further, the federated aggregator 804 may generate a global model update value 808 by federally aggregating the computed gradient update values received from each of the plurality of insurance systems 810A-810B using the secure multi-party computation model 806. Furthermore, the secure multi-party computation model 806 may ensure that the federated aggregation may be performed without any individual payer system gaining access to the gradient update values or local data 814A-814B of any other payer system, thereby preserving trade secrets and proprietary policy information.

Further, the global model update value 808 may be distilled back to each of the plurality of insurance systems 810A-810B via a knowledge distillation process. Furthermore, the knowledge distillation process may enable each payer system to update the Generative Artificial Intelligence (AI) models locally with globally aggregated adjudication knowledge while retaining payer-specific fine-tuning, improving adjudication accuracy by 12-15% across the plurality of insurance systems 810A-810B.

Further, the computer implemented system 102 may provide a plurality of technical advantages over conventional insurance claim adjudication systems. Furthermore, the computer implemented system 102 may drastically reduce the time required to process insurance claims through automated adjudication, leading to faster approvals and payments for claimants and healthcare providers. Further, the computer implemented system 102 may minimize human errors by consistently applying healthcare policy rules across all nodes of the decision tree during adjudication processing, ensuring greater accuracy in insurance claim adjudication decisions. Furthermore, the computer implemented system 102 may enable insurers and healthcare providers to reduce administrative costs associated with manual intervention and may allow for more effective allocation of resources across the adjudication workflow. The computer implemented system 102 may additionally handle large volumes of insurance claims simultaneously, making the computer implemented system 102 scalable for organizations of all sizes ranging from small healthcare providers to large insurance companies.

In an embodiment, the computer implemented system 102 may implement an error handling mechanism for managing ambiguous conditions and edge cases during adjudication. The error handling mechanism may include identifying ambiguous policy conditions based on a confidence score, where cases having a confidence score of less than 0.8 may be flagged for human review. Further, in scenarios involving conflicting rules, the system may prioritize a most recent policy version based on an associated timestamp. Further, claims corresponding to high-risk categories, including oncology, transplant procedures, or claims exceeding a predefined monetary threshold of $100,000, may be automatically flagged for additional review. Further, the error handling mechanism may include a fallback cascade. Further, upon failure of a large language model, processing may be successively performed using a rule engine followed by manual intervention.

In an embodiment, the computer implemented system 102 may generate tree-edit rewards based on human overrides performed on flagged insurance claims via the user interface dashboard on the user devices 118A-N. Furthermore, the tree-edit rewards may correspond to reward values assigned based on correct branch corrections performed by authorized human reviewers during manual review of flagged insurance claim adjudication decisions.

Further, the computer implemented system 102 may fine-tune the decision tree traversal policy of the second Generative Artificial Intelligence (AI) model using Proximal Policy Optimization (PPO) based on the generated tree-edit rewards. Furthermore, the PPO fine-tuning may employ a tree-aware state space including at least one of a current node and a claim embedding corresponding to the insurance claim being evaluated during traversal of the decision tree.

Further, in an embodiment, the Reinforcement Learning from Human Feedback (RLHF) process performed by the computer implemented system 102 may continuously improve the decision tree traversal policy of the second Generative Artificial Intelligence (AI) model based on accumulated tree-edit rewards from human overrides over time. Furthermore, the RLHF-based fine-tuning of the decision tree traversal policy may reduce human override rates by 28% over a period of three months of adjudication processing.

In an embodiment, the computer implemented system 102 may be deployed in a hybrid cloud environment using Amazon Web Services (AWS) Elastic Kubernetes Service (EKS) with GPU-accelerated EC2 P4d instances having A100 GPUs for Large Language Model (LLM) inference and CPU-optimized C6i instances for orchestration of the adjudication processing operations.

Further, the computer implemented system 102 may employ a Kubernetes Horizontal Pod Autoscaler (HPA) to scale pods between 1.5× and 10× based on at least one of a CPU utilization exceeding 70% and a claim queue length exceeding 100 insurance claims. Furthermore, the computer implemented system 102 may employ AWS Auto Scaling Groups to add or remove EKS node groups when sustained load may exceed 80% of available processing capacity.

Further, the computer implemented system 102 may employ serverless AWS Lambda functions for low-volume retrieval tasks associated with insurance claim data retrieval operations performed by the input data reception and decision rule extraction module 202. Furthermore, the computer implemented system 102 may employ a Redis cluster for prompt caching to reduce cold start latency by 60% during insurance claim adjudication processing.

Further, the computer implemented system 102 may handle a peak processing capacity of 2,500 insurance claims per minute with 99.9% uptime across the hybrid cloud deployment environment. Furthermore, the scalability mechanisms employed by the computer implemented system 102 may enable the computer implemented system 102 to maintain adjudication processing performance across varying insurance claim volumes without degradation in adjudication accuracy or system availability.

Further, the present disclosure may find application across a plurality of domains within the healthcare insurance industry. Furthermore, health insurers may employ the computer implemented system 102 to automate insurance claim processing operations, reducing administrative costs, and improving turnaround times for insurance claim adjudication decisions. Healthcare providers may utilize the computer implemented system 102 to streamline the submission and approval of insurance claims, reducing insurance claim denials attributable to errors or missing supporting claim information through the structured feedback and final adjudication module 210. Furthermore, the computer implemented system 102 may ensure consistent application of healthcare regulations across all insurance claim adjudication decisions by validating coverage conditions, diagnosis codes, and procedure codes against the pre-determined domain-specific knowledge graph via the knowledge graph validation module 208, thereby reducing the risk of regulatory audits or penalties for insurers and healthcare providers.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A computer implemented system for processing insurance claims using agentic Artificial Intelligence (AI) models, wherein the computer implemented system comprises:
a processor; and
a memory communicably coupled to the processor, wherein the memory comprises processor-executable instructions which, when executed by the processor, cause the processor to:
receive input data corresponding to an insurance from at least one user, wherein the input data comprises an insurance claim, a claimant history data, and a plurality of insurance policy documents;
extract a plurality of decision rules corresponding to the received input data by processing the plurality of insurance policy documents within the received input data using a first Generative Artificial Intelligence (Gen AI) model, wherein the plurality of decision rules corresponds to a natural language data format;
transform the extracted plurality of decision rules into a graph-based decision structure, wherein the graph-based decision structure comprises a decision tree with a plurality of nodes and a plurality of edges, and wherein each node represents a respective coverage condition obtained from the plurality of insurance policy documents;
generate an initial result for the insurance claim by evaluating the decision tree using a second Gen AI model;
generate a stepwise reasoning path corresponding to a traversal of the decision tree using a third Gen AI model based on the generated initial result, wherein the third Gen AI model corresponds to a chain-of-thought reasoning model;
validate at least one of diagnosis codes, procedure codes, claimant attributes, and coverage conditions corresponding to the plurality of nodes of the decision tree by querying a pre-determined domain-specific knowledge graph, wherein the pre-determined domain-specific knowledge graph comprises relationships among the plurality of decision rules;
detect at least one of an inconsistency in the coverage conditions and missing supporting claim data based on the generated stepwise reasoning path, results of validation and the pre-determined domain-specific knowledge graph; and
generate a structured feedback for the insurance claim using the third Gen AI model, wherein the structured feedback indicates a subset of nodes requiring re-evaluation and subsequent relevant claim data to be retrieved;
generate a final adjudication result by fine-tuning the traversal of the decision tree and updating the initial result using the second Gen AI model based on the structured feedback; and
output the final result and an explanation data for the final result on a user interface of a user device.

2. The computer-implemented system of claim 1, wherein to extract the plurality of decision rules corresponding to the received input data, the processor is configured to:
identify one or more relevant sections of the plurality of insurance policy documents by performing a semantic search using one or more vector embeddings of the plurality of insurance policy documents and embeddings of a claim type, the diagnosis codes, and the procedure codes from the input data;
generate one or more prompts for the input data using the first generative AI model, wherein the one or more prompts comprise the identified one or more relevant sections and the input data;
identify the coverage conditions as natural language condition-action pairs by processing the generated one or more prompts using the first generative AI model, wherein the coverage conditions comprise an eligibility criteria, prior authorization requirements, coverage exclusions, treatment limitations, and reimbursement conditions;
generate natural language responses to the one or more prompts by applying the one or more prompts to the first Gen AI model;
identify condition phrases and corresponding action phrases by parsing the generated natural language responses using regular expressions model and rule-based post-processing model;
validate the condition phrases and the corresponding action phrases based on a predefined ontology model; and
embed the condition phrases and the corresponding action phrases into the plurality of decision rules, wherein the plurality of decision rules comprise rule identifiers, source policy sections, natural language conditions, and natural language actions.

3. The computer-implemented system of claim 1, wherein to transform the extracted plurality of decision rules into the graph-based decision structure, the processor is configured to:
preprocess natural language conditions and natural language actions within the extracted plurality of decision rules into a standardized intermediate representation by applying at least one of a tokenization process, a syntactic parsing process, and a semantic role labeling process on the extracted plurality of decision rules;
identify one or more decision variables, conditional operators, and outcome actions associated with each of the plurality of decision rules based on the standardized intermediate representation;
map the identified one or more decision variables to corresponding claim attributes using a predefined ontology model, wherein the claim attributes comprise at least one of the diagnosis codes, the procedure codes, the claimant attributes, and policy parameters;
classify each of the plurality of decision rules into one of a plurality of rule types based on the mapping, wherein the plurality of rule types comprise eligibility rules, exclusion rules, dependency rules, and sequencing rules;
determine logical dependencies among the plurality of decision rules by analyzing at least one of shared decision variables, conditional relationships, and hierarchical policy structures;
generate a directed graph structure by assigning each of the plurality of decision rules to a corresponding node, and directed edges between nodes based on the determined logical dependencies and an evaluation order;
convert the directed graph structure into the decision tree by assigning a root node corresponding to an initial eligibility condition, generating intermediate nodes corresponding to conditional evaluations, and defining leaf nodes corresponding to results, wherein the results comprise one of an approval, a denial, and flagging for review;
encode a corresponding evaluation function for each node based on the decision tree, wherein the corresponding evaluation function comprises the coverage condition, the claim attributes, and decision thresholds obtained from the plurality of insurance policy documents;
determine overlapping decision rules by applying at least one of a priority ranking, a rule weighting, and conflict resolution heuristics to the decision tree based on a policy hierarchy and a rule specificity;
validate a structural consistency of the decision tree by determining completeness of the corresponding evaluation function, absence of cyclic dependencies, and coverage of relevant policy conditions; and
generate the decision tree in a machine-readable format based on the validated structural consistency of the decision tree.

4. The computer-implemented system of claim 1, wherein to generate the initial result for the insurance claim by evaluating the decision tree using the second Gen AI model, the processor is configured to:
initialize a traversal process at a root node of the decision tree corresponding to an initial coverage condition;
generate a contextual representation of the relevant claim data using the second generative AI model by encoding at least one of the insurance claim, claimant history data, and policy-related attributes;
traverse the decision tree by iteratively evaluating the plurality of nodes using the second generative AI model until a terminal node corresponding to a result is reached;
generate a reasoning sequence associated with the insurance claim by aggregating node-level decision outputs generated across the traversal;
determine the initial result based on the result associated with the terminal node; and
generate intermediate decision metadata comprising at least one of traversal paths, evaluated coverage conditions, retrieved claim data, and the node-level decision outputs.

5. The computer-implemented system of claim 4, wherein to iteratively evaluate the plurality of nodes using the second generative AI model, the processor is configured to:
retrieve a corresponding evaluation function for each node detected during traversal of the decision tree, wherein the corresponding evaluation function comprises the coverage condition, the claim attributes, and a decision criteria;
generate a context-aware prompt using the second generative AI model, wherein the context-aware prompt comprises the coverage condition, the claim attributes, and the contextual representation of the relevant claim data; and
generate a node-level decision output by evaluating the coverage condition with the relevant claim data using the generated context-aware prompt, wherein the node-level decision output indicates one of a satisfaction of the coverage condition and a non-satisfaction of the coverage condition.

6. The computer-implemented system of claim 1, wherein to generate the stepwise reasoning path corresponding to the traversal of the decision tree using the third Gen AI model based on the generated initial result, the processor is configured to:
receive at least one of the initial result, intermediate decision metadata, traversal paths, and the decision tree generated by the second generative AI model;
regenerate a sequence of nodes traversed during evaluation of the decision tree based on the received initial result, the intermediate decision metadata, the traversal paths, and the decision tree, wherein the sequence of nodes comprise an order of evaluation of the plurality of nodes;
extract the coverage conditions, node-level decision outputs, and the claim attributes for each node in the regenerated sequence of nodes;
generate a structured prompt using the third generative AI model, wherein the structured prompt comprises the regenerated sequence of nodes, the coverage conditions, the claim attributes, and the node-level decision outputs;
iteratively process the structured prompt using the third generative AI model to generate a sequence of intermediate reasoning steps, wherein each intermediate reasoning step comprises an explanation to an evaluation of a respective node;
generate a node-aligned reasoning sequence by mapping each intermediate reasoning step with a corresponding node in the decision tree, wherein the intermediate reasoning step comprises references to supporting evidence from the claim data and sections in the plurality of insurance policy documents;
validate a logical consistency within the sequence of the intermediate reasoning steps to determine an alignment between the node-level decision outputs and the coverage conditions; and
generate the stepwise reasoning path as an ordered chain-of-thought representation based on the validated logical consistency, wherein the stepwise reasoning path comprises the sequence of intermediate reasoning steps corresponding to the traversal of the decision tree.

7. The computer-implemented system of claim 1, wherein to validate the at least one of the diagnosis codes, the procedure codes, the claimant attributes, and the coverage conditions corresponding to the plurality of nodes of the decision tree, the processor is configured to:
extract validation elements from the at least one of the stepwise reasoning path, the intermediate decision metadata, and the traversal paths, wherein the validation elements comprise the diagnosis codes, the procedure codes, the claimant attributes, the coverage conditions applied at each node, and the node-level decision outputs;
preprocess the extracted validation elements into a standardized representation using at least one of an ontology mapping process, a code normalization process, and a semantic alignment process;
generate one or more structured queries for the pre-determined domain-specific knowledge graph by mapping the preprocessed validation elements to corresponding entities and relationships encoded within the pre-determined domain-specific knowledge graph, wherein each query corresponds to a validation check associated with at least one node of the decision tree;
execute the one or more structured queries on the pre-determined domain-specific knowledge graph to retrieve relationship data representing one or more dependencies among the plurality of insurance policy rules, the diagnosis codes, the procedure codes, and the claimant attributes;
determine whether the coverage conditions are consistent with the relationships encoded in the pre-determined domain-specific knowledge graph by comparing the retrieved relationship data with the coverage conditions applied at the plurality of nodes;
evaluate whether the diagnosis codes and the procedure codes satisfy policy-defined eligibility constraints, the claimant attributes comply with policy-specific conditions, and the coverage conditions reflect the dependencies among the extracted validation elements;
generate one or more validation results comprising at least one of consistency of the coverage conditions, inconsistency between the coverage conditions and knowledge graph relationships, and absence of required relationships in the pre-determined domain-specific knowledge graph; and
generate validation metadata indicating a validation status and corresponding conflicting relationships retrieved from the pre-determined domain-specific knowledge graph.

8. The computer-implemented system of claim 1, wherein to detect the at least one of the inconsistency in the coverage conditions and the missing supporting claim data based on the generated stepwise reasoning path, the results of validation and the pre-determined domain-specific knowledge graph, the processor is configured to:
receive at least one of the stepwise reasoning path, the validation metadata, the intermediate decision metadata, and the traversal paths associated with evaluation of the decision tree;
extract one or more comparison elements from the received information, wherein the one or more comparison elements comprise the node-level decision outputs, the coverage conditions applied at each node, the claim attributes, the diagnosis codes, the procedure codes, and the results of validation obtained from the pre-determined domain-specific knowledge graph;
align the comparison elements for each node by correlating the node-level decision outputs with the coverage conditions and the results of validation;
determine an expected outcome based on the relationships retrieved from the pre-determined domain-specific knowledge graph and the claim attributes;
compare the node-level decision outputs with the expected outcomes to identify discrepancies between the coverage conditions and the relationships defined in the pre-determined domain-specific knowledge graph;
identify an inconsistency in the coverage conditions if the node-level decision output deviates from the expected outcome obtained from the pre-determined domain-specific knowledge graph, the coverage condition contradicts the relationships encoded in the pre-determined domain-specific knowledge graph, and the sequence of reasoning steps in the stepwise reasoning path indicates logical conflicts for the plurality of nodes;
detect one or more issues in the generated stepwise reasoning path and the results of validation, wherein the one or more issues comprise at least one of an absence of required claim attributes, the diagnosis codes, and the procedure codes associated with the coverage condition, a presence of unsupported stepwise reasoning path references, and an absence of required dependencies;
classify each detected issue as at least one of a logical inconsistency, a policy inconsistency, a data insufficiency, and an incomplete evaluation condition; and
generate inconsistency metadata for each detected issue, wherein the inconsistency metadata comprises at least one of an identifier of the corresponding node, a type of inconsistency, missing information, a description of the discrepancy, and a reference to the coverage condition and the results of validation.

9. The computer-implemented system of claim 1, wherein to generate the structured feedback for the insurance claim using the third Gen AI model, the processor is configured to:
identify a subset of nodes of the decision tree associated with detected inconsistencies and missing supporting claim data based on the stepwise reasoning path, the inconsistency metadata, the validation metadata, the intermediate decision metadata, and the traversal paths associated with evaluation of the decision tree;
classify an issue type for each node in the subset of nodes, wherein the issue type comprises at least one of a logical inconsistency, a policy inconsistency, a data insufficiency, and an incomplete evaluation condition;
extract the coverage conditions, node-level decision outputs, the claim attributes, and the results of validation for each node in the subset of nodes;
generate a structured prompt using the third generative AI model, wherein the structured prompt comprises the identified subset of nodes, the issue type, the coverage conditions, the node-level decision outputs, and the results of validation;
generate corrective reasoning instructions for each node in the subset of nodes by processing the structured prompt using the third generative AI model;
determine one or more re-evaluation actions based on the corrective reasoning instructions, wherein the one or more re-evaluation actions comprises re-evaluating the coverage condition, modifying a decision threshold, revisiting a traversal path, and requesting supporting data;
identify relevant claim data required to resolve the detected issue for each node requiring re-evaluation, wherein the relevant claim data comprises at least one of missing diagnosis codes, missing procedure codes, incomplete claimant attributes, and absent supporting documentation; and
generate the structured feedback for each node in the subset of nodes, wherein the structured feedback comprises a node identifier, the issue type, a re-evaluation instruction, a specification of the relevant claim data to be retrieved, and a priority level associated with the re-evaluation.

10. The computer-implemented system of claim 1, wherein to generate the final result by refining the traversal of the decision tree and updating the initial result using the second generative artificial intelligence (AI) model based on the structured feedback, the processor is configured to:
identify the subset of nodes requiring re-evaluation and corresponding re-evaluation instructions based on the structured feedback;
retrieve subsequent relevant claim data specified in the structured feedback from at least one of a data retrieval subsystem, external data sources, and the input data;
update the contextual representation of the relevant claim data based on the retrieved subsequent claim data;
selectively re-traverse the decision tree by re-evaluating the subset of nodes identified in the structured feedback;
reconstruct a node-specific evaluation context for each node in the subset of nodes, wherein the node-specific evaluation context comprises the updated claim data and the coverage condition;
generate a revised context-aware prompt using the second generative AI model;
generate an updated node-level decision output by re-evaluating the coverage condition; and
generate an updated result as the final adjudication result by recomputing a traversal path based on the updated node-level decision output.

11. The computer-implemented system of claim 1, wherein the processor is configured to:
perform federated fine-tuning of the first generative AI model, the second generative AI model, and the third generative AI model corresponding to a plurality of insurance systems using a secure multi-party computation model;
perform a quantum-inspired routing of the insurance claim to an optimal combination of the first generative AI model, the second generative AI model, and the third generative AI model;
perform a self-healing of multiple parallel processing ensembles of the first generative AI model, the second generative AI model, and the third generative AI model using a Bayesian uncertainty quantification model; and
generate the final result referencing the plurality of insurance policy documents and the plurality of nodes of the decision tree based on the performed federated fine-tuning, the quantum-inspired routing and the self-healing process.

12. The computer-implemented system of claim 11, wherein to perform the fine-tuning of the first generative AI model, the second generative AI model, and the third generative AI model, the processor is configured to:
fine-tune the first generative AI model, the second generative AI model, and the third generative AI model locally at each of the insurance systems using a specific training data comprising insurance claims and the plurality of policy documents;
compute one or more gradient update values based on the fine-tuned first generative AI model, the fine-tuned second generative AI model, and the fine-tuned third generative AI model; and
generate a global model update value by federally aggregating the computed one or more gradient update values for each of the plurality of insurance systems using the secure multi-party computation model.

13. The computer-implemented system of claim 11, wherein to perform the quantum-inspired routing of the insurance claim to the optimal combination of the first generative AI model, the second generative AI model, and the third generative AI model, the processor is configured to:
determine a cost function value comprising at least one of a decision tree depth, claim risk factors, and a historical model performance for a plurality of combinations of the first generative AI model, the second generative AI model, and the third generative AI model, wherein the claim risk factors comprise a billed amount, a procedure complexity, and claimant health attributes;
select an optimal model combination by applying a simulated quantum annealing process to adjust the determined cost function value; and
route the insurance claim to the selected optimal model combination for processing the insurance claim.

14. The computer-implemented system of claim 11, wherein to perform the self-healing of the multiple parallel processing ensembles of the first generative AI model, the second generative AI model, and the third generative AI model using the Bayesian uncertainty quantification model, the processor is configured to:
execute a plurality of parallel instances of extracting decision rules using the first generative AI model, forming the decision tree, traversing the decision tree using the second generative AI model, and reviewing the result using the third generative AI model, wherein each parallel instance corresponds to an independent variant of the first generative AI model, the second generative AI model, and the third generative AI model;
compute one or more confidence scores corresponding to outputs of each of the plurality of parallel instances using a Monte Carlo dropout sampling model;
detect one or more deviations in the computed one or more confidence scores based on a predefined threshold value;
automatically retrain at least one specific parallel instance deviating from the predefined threshold value based on the detected one or more deviations using synthetic insurance claims generated by the first generative AI model; and
select the final result as a weighted combination of the outputs of each of the plurality of parallel instances.

15. The computer-implemented system of claim 14, wherein the processor is configured to:
detect at least one deviation in the pre-determined domain-specific knowledge graph by comparing one or more distributions of the relationships encoded in the pre-determined domain-specific knowledge graph before and after processing updated insurance policy documents using the first generative AI model; and
generate synthetic test claims using the first generative AI model in response to detecting the at least one deviation in the pre-determined domain-specific knowledge graph.

16. A method for processing insurance claims using agentic Artificial Intelligence (AI) models, wherein the method comprises:
receiving, by the processor, input data corresponding to an insurance from at least one user, wherein the input data comprises an insurance claim, a claimant history data, and a plurality of insurance policy documents;
extracting, by the processor, a plurality of decision rules corresponding to the received input data by processing the plurality of insurance policy documents within the received input data using a first Generative Artificial Intelligence (Gen AI) model, wherein the plurality of decision rules corresponds to a natural language data format;
transforming, by the processor, the extracted plurality of decision rules into a graph-based decision structure, wherein the graph-based decision structure comprises a decision tree with a plurality of nodes and a plurality of edges, and wherein each node represents a respective coverage condition obtained from the plurality of insurance policy documents;
generating, by the processor, an initial result for the insurance claim by evaluating the decision tree using a second Gen AI model;
generating, by the processor, a stepwise reasoning path corresponding to a traversal of the decision tree using a third Gen AI model based on the generated initial result, wherein the third Gen AI model corresponds to a chain-of-thought reasoning model;
validating, by the processor, at least one of diagnosis codes, procedure codes, claimant attributes, and coverage conditions corresponding to the plurality of nodes of the decision tree by querying a pre-determined domain-specific knowledge graph, wherein the pre-determined domain-specific knowledge graph comprises relationships among the plurality of decision rules;
detecting, by the processor, at least one of an inconsistency in the coverage conditions and missing supporting claim data based on the generated stepwise reasoning path, results of validation and the pre-determined domain-specific knowledge graph; and
generating, by the processor, a structured feedback for the insurance claim using the third Gen AI model, wherein the structured feedback indicates a subset of nodes requiring re-evaluation and subsequent relevant claim data to be retrieved;
generating, by the processor, a final adjudication result by fine-tuning the traversal of the decision tree and updating the initial result using the second Gen AI model based on the structured feedback; and
outputting, by the processor, the final result and an explanation data for the final result on a user interface of a user device.
